(19) United States
(12) Patent Application Publication
(10) Pub. No.: US 2021/0252693 A1
(43) Pub. Date: Aug. 19, 2021

(54) APPARATUS WITH MULTIPLE HINGEDLY COUPLED LINKS

(71) Applicant: BRIGHAM YOUNG UNIVERSITY, Provo, UT (US)

(72) Inventors: Larry L. Howell, Orem, UT (US); Spencer T Magleby, Provo, UT (US); Todd G. Nelson, Provo, UT (US); Jacob R. Greenwood, Provo, UT (US)

(21) Appl. No.: 17/250,201

(22) PCT Filed: Jun. 17, 2019
(86) PCT No.: PCT/US2019/037497

§ 371 Date: Dec. 14, 2020

Related U.S. Application Data
(60) Provisional application No. 62/685,568, filed on Jun. 15, 2018.

(51) Int. Cl. B25J 9/00; B25J 9/10

(52) U.S. Cl. CPC B25J 9/0048; B25J 9/106

(57) ABSTRACT

An apparatus can comprise multiple links, the multiple links comprising at least a first link, a second link, a third link, and a base link, each of the multiple links comprising a rigid sheet, the first link being hingedly coupled to the second link via a first joint, the second link being hingedly coupled to the third link via a second joint, the third link being hingedly coupled to the base link via a third joint, the base link being hingedly coupled to the first link via a fourth joint. The multiple links defining at least a portion of a cylinder when the apparatus is in a stowed position, the first joint, second joint, third joint, and fourth joint being aligned parallel to each other and aligned parallel to a longitudinal axis of the cylinder.

### CROSS-REFERENCE TO RELATED APPLICATION

This application claims priority to U.S. Provisional Patent Application No. 62/685,568, filed Jun. 15, 2018, titled “Developable Mechanisms on Developable Surfaces,” which is incorporated herein by reference in its entirety.

### TECHNICAL FIELD

This description relates to linked mechanisms.

### BACKGROUND

Mechanical systems can be designed to perform complex tasks. Larger mechanical systems can occupy an undesirable amount of space.

### SUMMARY

An apparatus can comprise multiple links. The multiple links can comprise at least a first link, a second link, a third link, and a base link. Each of the multiple links can comprise a rigid sheet. The first link can be hingedly coupled to the second link via a first joint, the second link can be hingedly coupled to the third link via a second joint, the third link can be hingedly coupled to the base link via a third joint, and the base link can be hingedly coupled to the first link via a fourth joint. The multiple links can define at least a portion of a cylinder when the apparatus is in a stowed position. The first joint, second joint, third joint, and fourth joint can be aligned parallel to each other and aligned parallel to a longitudinal axis of the cylinder.

An apparatus can comprise multiple links. The multiple links can comprise at least a first link, a second link, a third link, and a base link. Each of the multiple links can comprise a rigid sheet. The first link can be hingedly coupled to the second link via a first joint, the second link can be hingedly coupled to the third link via a second joint, the third link can hingedly coupled to the base link via a third joint, and the base link can be hingedly coupled to the first link via a fourth joint. The multiple links can define at least a portion of a cone when the apparatus is in a stowed position. Axes of the first joint, the second joint, the third joint, and the fourth joint can point toward an apex of the cone.

An apparatus can comprise multiple links. The multiple links can comprise at least a first link, a second link, a third link, and a base link. Each of the multiple links can comprise a rigid sheet. The first link can be hingedly coupled to the second link via a first joint, the second link can be hingedly coupled to the third link via a second joint, the third link can be hingedly coupled to the base link via a third joint, and the base link can be hingedly coupled to the first link via a fourth joint. The multiple links can define at least a portion of a curved surface when the apparatus is in a stowed position. An axis of the first joint can be parallel to a first tangent of the curved surface, an axis of the second joint can be parallel to a second tangent of the curved surface, an axis of the third joint can be parallel to a third tangent of the curved surface, and an axis of the fourth joint can be parallel to a fourth tangent of the curved surface.

The details of one or more implementations are set forth in the accompanying drawings and the description below. Other features will be apparent from the description and drawings, and from the claims.

### BRIEF DESCRIPTION OF THE DRAWINGS

FIG. 1A shows an apparatus with multiple links defining at least a portion of a cylinder in a stowed position.

FIG. 1B shows the apparatus of FIG. 1A in a deployed position.

FIG. 1C shows joint axes of the apparatus of FIG. 1A.

FIG. 1D shows an apparatus with multiple links in offset positions defining at least a portion of a cylinder in a stowed position.

FIG. 1E shows the apparatus of FIG. 1D in a deployed position.

FIG. 1F shows joint axes of the apparatus of FIG. 1D.

FIG. 2A shows a schematic cylinder with ruling lines.

FIG. 2B shows joint axes aligned with the ruling lines shown in FIG. 2A.

FIG. 2C shows the joint axes of FIG. 2B in the schematic cylinder of FIG. 2A.

FIG. 3A shows an apparatus with multiple links defining at least a portion of a cylinder in a stowed position.

FIG. 3B shows an apparatus with multiple links defining at least a portion of a cylinder in a deployed position.

FIG. 4A shows an apparatus with multiple links defining at least a portion of a cylinder in a stowed position.

FIG. 4B shows an apparatus with multiple links defining at least a portion of a cylinder in a deployed position.

FIG. 5A shows an apparatus with multiple links defining at least a portion of a cylinder with a rotation mechanism in a stowed position.

FIG. 5B shows the apparatus of FIG. 5A in the stowed position.

FIG. 5C shows the apparatus of FIGS. 5A and 5B in the stowed position.

FIGS. 5D, 5E, and 5F show the apparatus of FIGS. 5A, 5B, and 5C in deployed positions.

FIGS. 6A, 6B, 6C, 6D, 6E, 6F, 6G, and 6H show Denavit-Hartenberg (DH) parameters for mechanisms described herein.

FIGS. 7A, 7B, 7C, 7D, 7E, 7F, 7G, 7H, 7I, 7J, 7K show creating a mechanism described herein.

FIGS. 8A, 8B, 8C, 8D, 8E, 8F, 8G, and 8H show motion of links of an apparatus with multiple links defining at least a portion of a cylinder.

FIG. 9 shows an apparatus with multiple links defining at least a portion of a cylinder in a deployed position.

FIG. 10 shows an apparatus with multiple links defining at least a portion of a cylinder with a rotation mechanism in a deployed position.

FIG. 11A shows an apparatus with multiple links defining at least a portion of a cylinder in a stowed position.

FIG. 11B shows the apparatus of FIG. 11A in a deployed position.

FIG. 11C shows the apparatus of FIGS. 11A and 11B in a deployed position.

FIG. 12A shows a schematic portion of a three-dimensional cone with ruling lines.

FIG. 12B shows a schematic portion of a two-dimensional cone with ruling lines.

FIG. 12C shows joint axes aligned with the ruling lines of FIG. 12A.

FIG. 12D shows joint axes aligned with the ruling lines of FIG. 12B.

FIG. 12E shows links in the cone of FIG. 12A.

FIG. 12F shows links in the cone of FIG. 12B.

FIG. 13A shows an apparatus with multiple links defining at least a portion of a cone in a stowed position.

FIGS. 13B, 13C, and 13D shows the apparatus of FIG. 13A in a deployed position.

FIG. 14A shows a schematic cone with ruling lines.

FIG. 14B shows joints with axes aligned with the ruling lines of FIG. 14A.

FIG. 14C shows the schematic cone of FIG. 14A with the joints of FIG. 14B.

FIG. 14D shows an apparatus with multiple links defining at least a portion of a cone in a stowed position.

FIG. 14E shows the apparatus of FIG. 14D in a deployed position.

FIGS. 15A, 15B, 15C, 15D, and 15E show a schematic cone.

FIG. 16A shows an apparatus with multiple links defining at least a portion of a cone in a stowed position.

FIGS. 16B, 16C, and 16D show the apparatus of FIG. 16A in a deployed position.

FIG. 17A shows a schematic tangent mechanism with ruling lines.

FIG. 17B shows joints with joint axes aligned with the ruling lines shown in FIG. 17A.

FIG. 17C shows the schematic tangent mechanism of FIG. 17A with the joints of FIG. 17B.

FIG. 17D shows an apparatus with multiple links defining at least a portion of a curved surface and joints parallel to tangents of the curved surface in a stowed position.

FIG. 17E shows the apparatus of FIG. 17D in a deployed position.

FIG. 18A is a schematic of a traditional joint and an associated axis.

FIG. 18B shows a traditional joint and links coupled via the traditional joint.

FIG. 19A shows a schematic of a compliant joint and an associated axis.

FIG. 19B shows a compliant joint and links coupled via the compliant joint.

### DETAILED DESCRIPTION

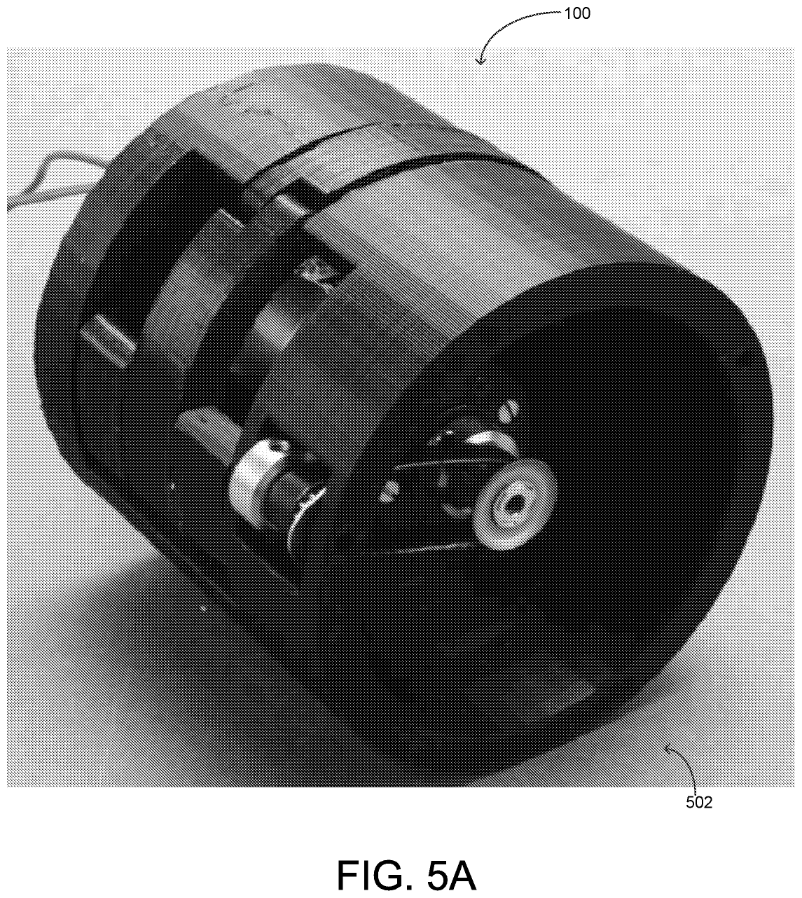

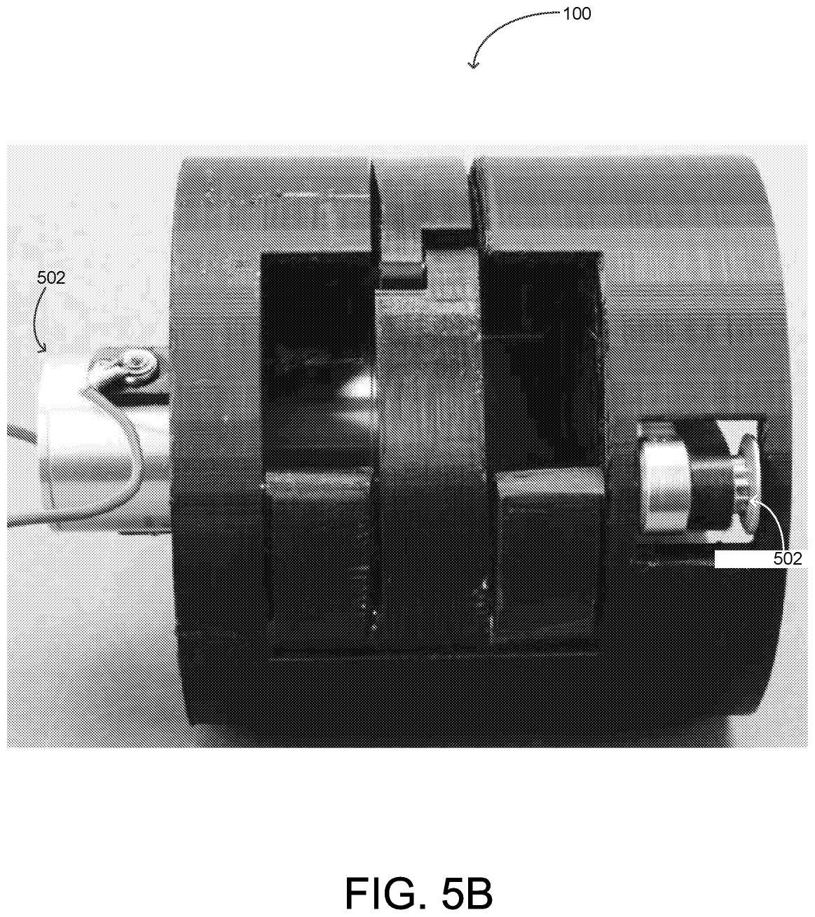

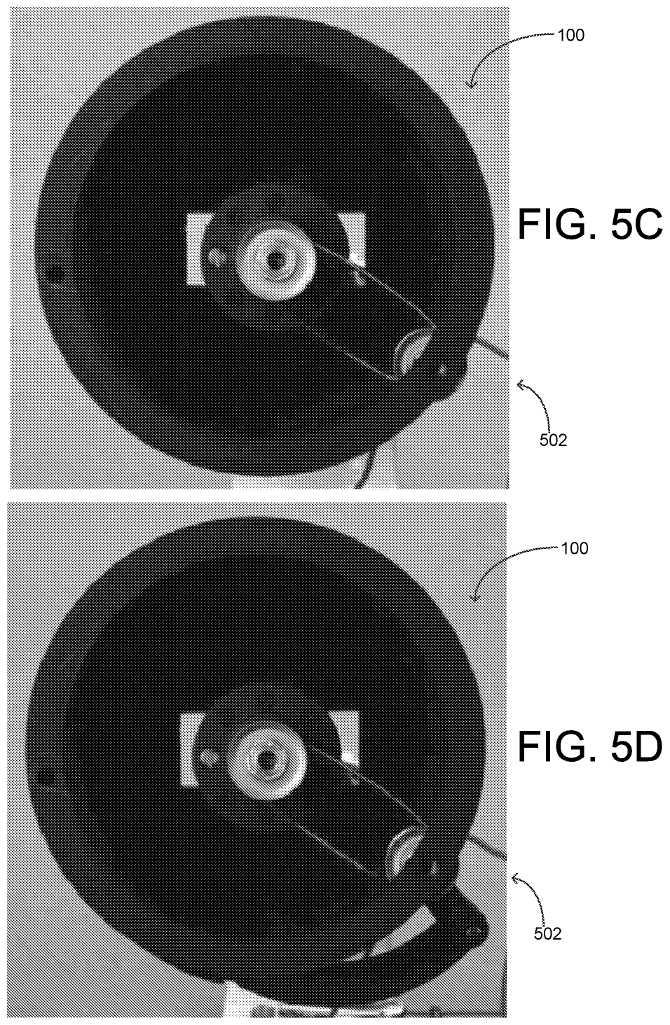

Compact mechanical systems integrated with curved surfaces described herein can perform complex tasks while maintaining smaller mechanism footprints and volumes. Shapes described herein, such as cylinders, cones, tangent surfaces, and/or portions thereof, can be built from developable surfaces. Developable surfaces can be shapes that a flat and/or rigid sheet can take by bending without tearing or stretching, such as a metal or plastic sheet. The mechanisms described herein can include links hingedly coupled to each other by joints and/or hinges, and joint axes and/or hinge axes can be aligned with ruling lines of the developable surfaces, described below, to enable mobility of the mechanisms. The links can take the shape of the developable surface. Apparatuses described herein can be formed from developable surfaces. In some examples, an apparatus can include a cylinder rotating inside a cylinder, with one or both of the cylinders including links and/or joints described herein, and the apparatus including a rotation mechanism (such as the rotation mechanism shown and described with respect to FIGS. 5A, 5B, 5C, 5D, 5E, and 5F) to cause one of the cylinders to rotate with respect to the other cylinder. In some examples, an apparatus can include a cone rotating inside a cone, with one or both of the cones including links and/or joints described herein, and the apparatus including a rotation mechanism to cause one of the cones to rotate with respect to the other cone.

Compact mechanical systems described herein can perform complex tasks, such as minimally invasive surgery (which can be improved by smaller incisions), or improving air vehicle flight time and ground vehicle fuel efficiency by shape manipulation. The mechanisms described herein can perform the complex tasks while minimizing size by stowing into small positions such as cylinders, cones, or tangent surfaces. Manufacturing these mechanisms from a single developable surface can reduce the cost of manufacturing the mechanisms.

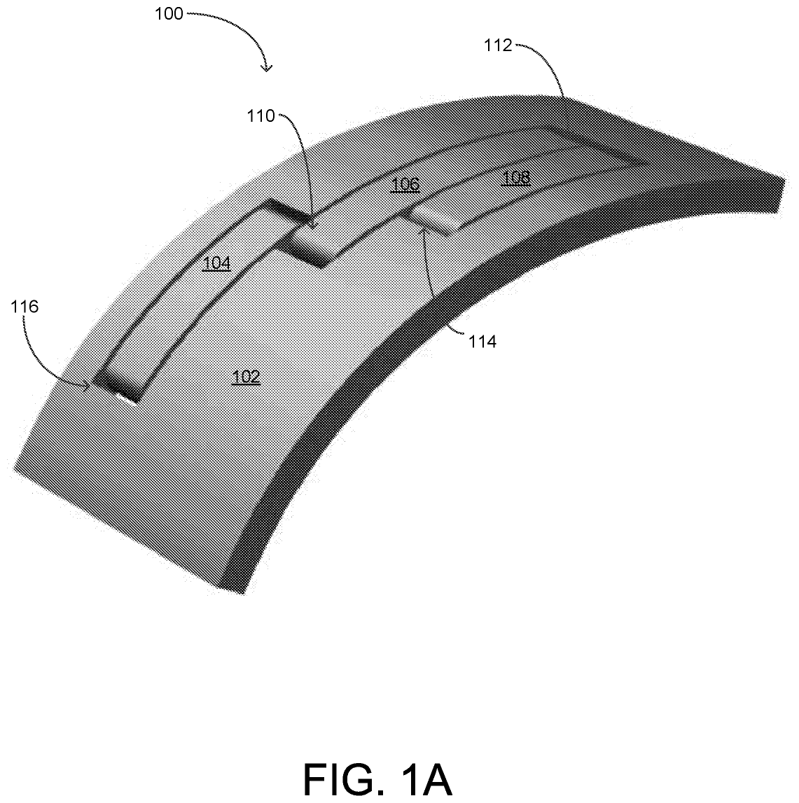

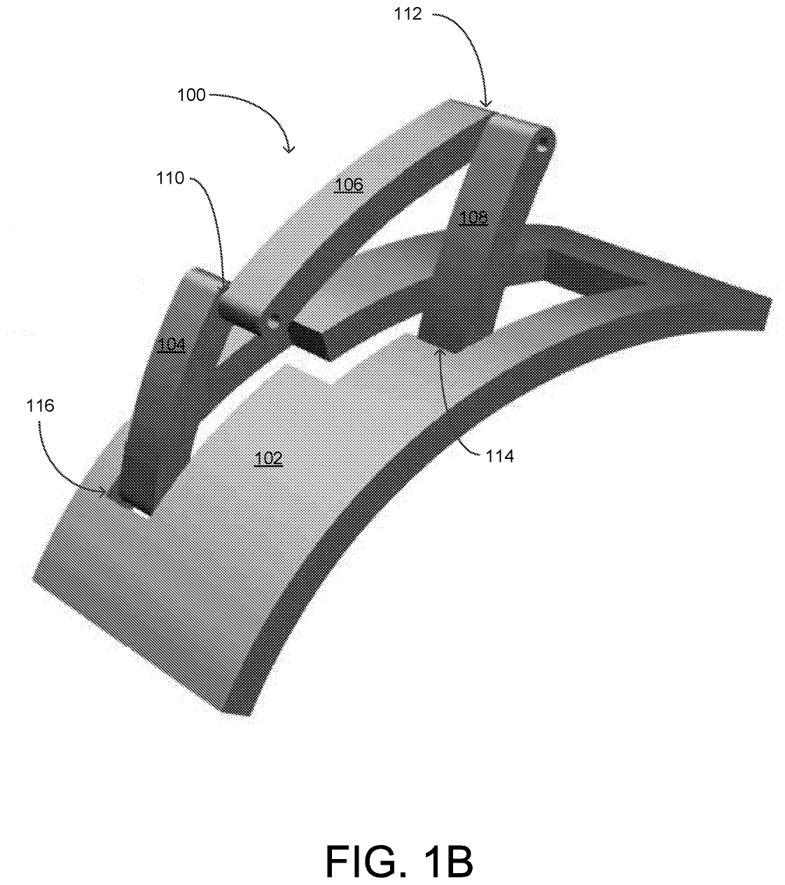

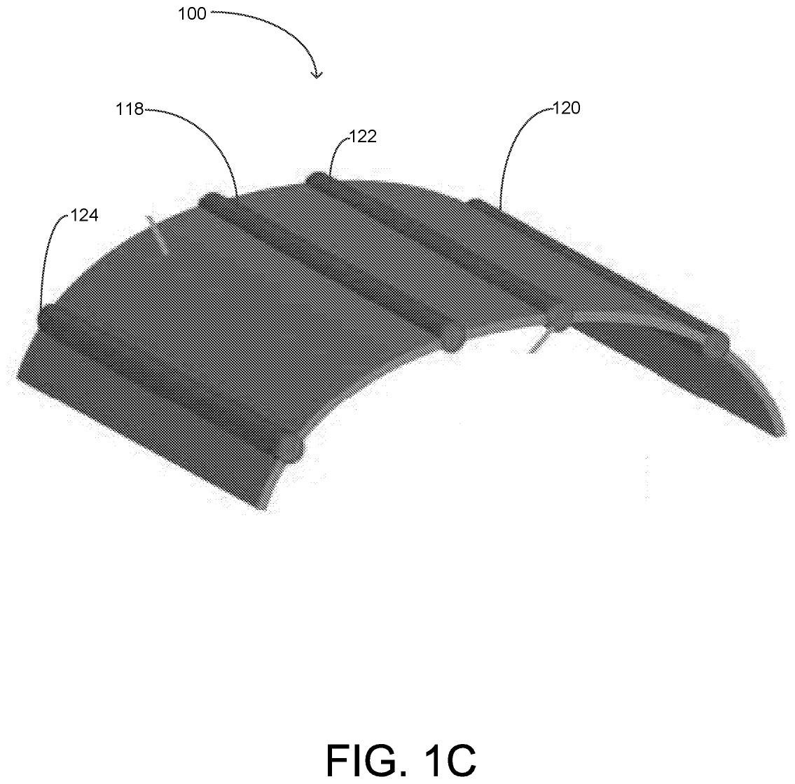

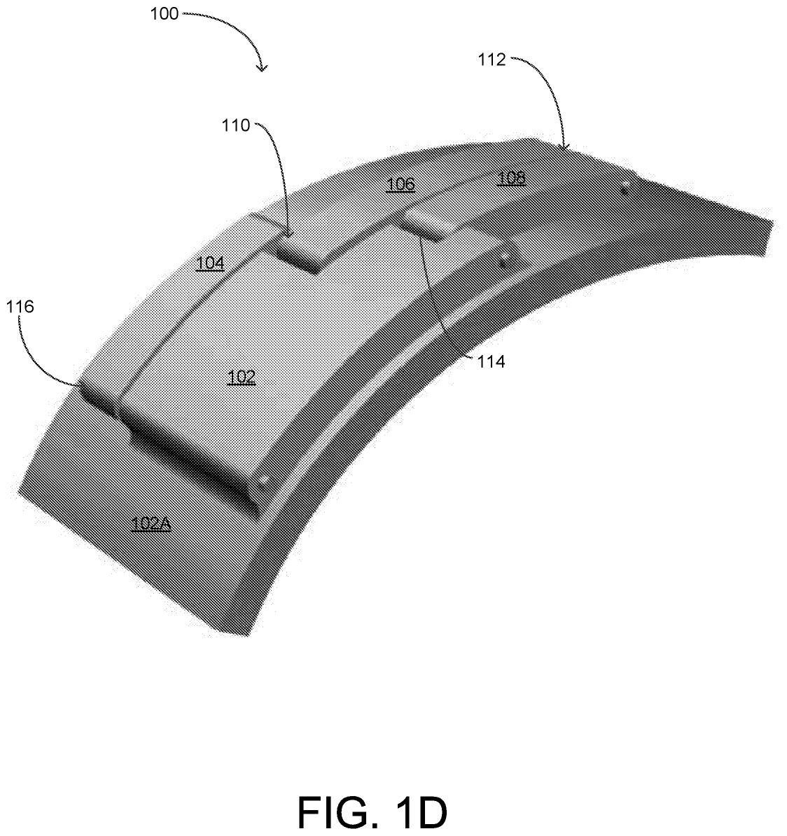

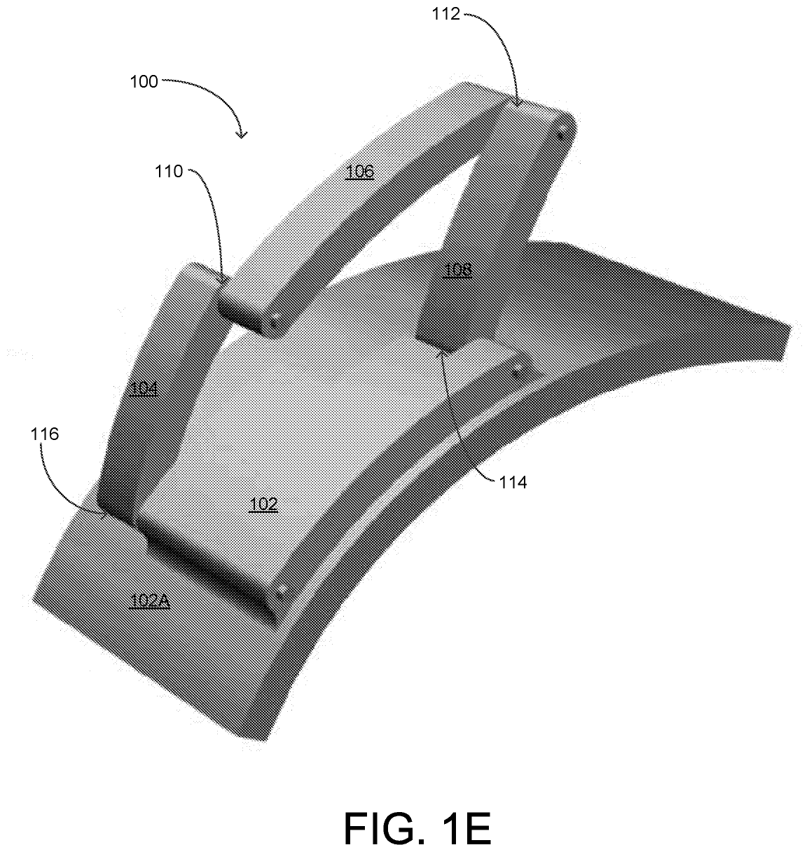

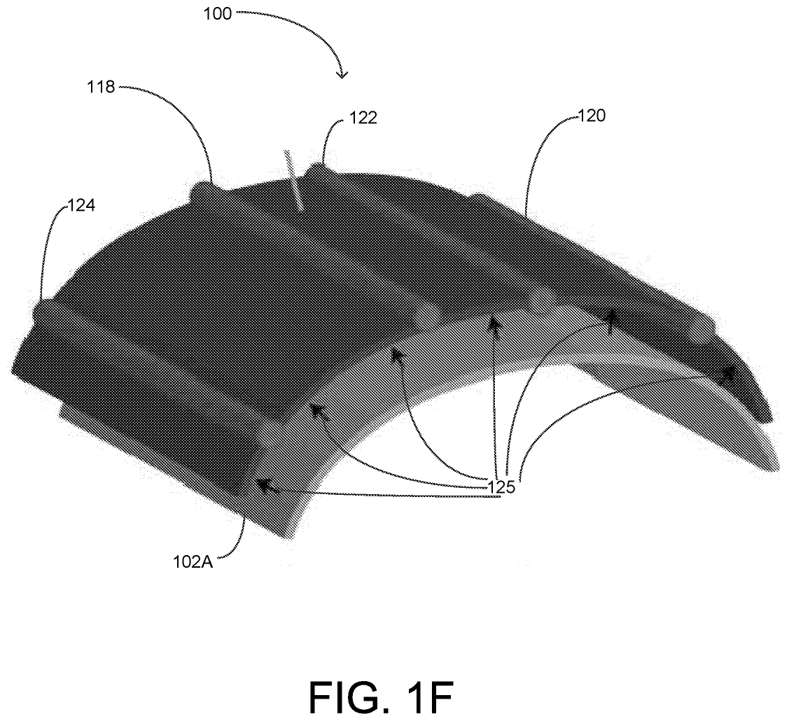

FIG. 1A shows an apparatus 100 with multiple links 102, 104, 106, 108 defining at least a portion of a cylinder in a stowed position. The apparatus 100 can be formed from a developable surface, such as a rigid sheet of metal bent into a partial cylinder. The apparatus can comprise multiple links hingedly coupled to each other by joints. The joints can be aligned parallel to each other and parallel to a longitudinal axis of the partial cylinder. When the apparatus is in a stowed, closed, and/or conforming position, the multiple links 102, 104, 106, 108 can define at least a portion of a cylinder.

In the example shown in FIG. 1A, the apparatus comprises a base link 102, a first link 104, a second link 106, and a third link 108. The links 102, 104, 106, 108 can all have a same radius of curvature as each other and as the cylinder. The first link 104 can be hingedly coupled to the second link 106 via a first joint 110. The second link 106 can be hingedly coupled to the third link via a second joint 112. The third link 108 can be hingedly coupled to the base link 102 via a third joint 114. The base link 102 can be hingedly coupled to the first link 104 via a fourth joint 116.

In some examples, a mass of the base link 102 can be greater than a mass of the first link 104, the mass of the base link 102 can be greater than a mass of the second link 106, and the mass of the base link 102 can be greater than a mass of the third link 108. In some examples, each of the base link 102, the first link 104, the second link 106, and the third link 108 rotates no more than three hundred sixty degrees (360°) around the cylinder (and/or portion of a cylinder) defined by the links 102, 104, 106, 108. In some examples, one or more, or all, of the links 102, 104, 106, 108 can rotate three hundred sixty degrees (360°) or more around the cylinder (and/or portion of a cylinder) defined by the links 102, 104, 106, 108. In the example shown in FIG. 1A, in the stowed position, the first joint 110 can be closer to the third joint 114 than to the second joint 112, enabling ends of the second and third links adjacent to the second joint 112 to move up and/or away from the base link 102, as shown in FIG. 1B.

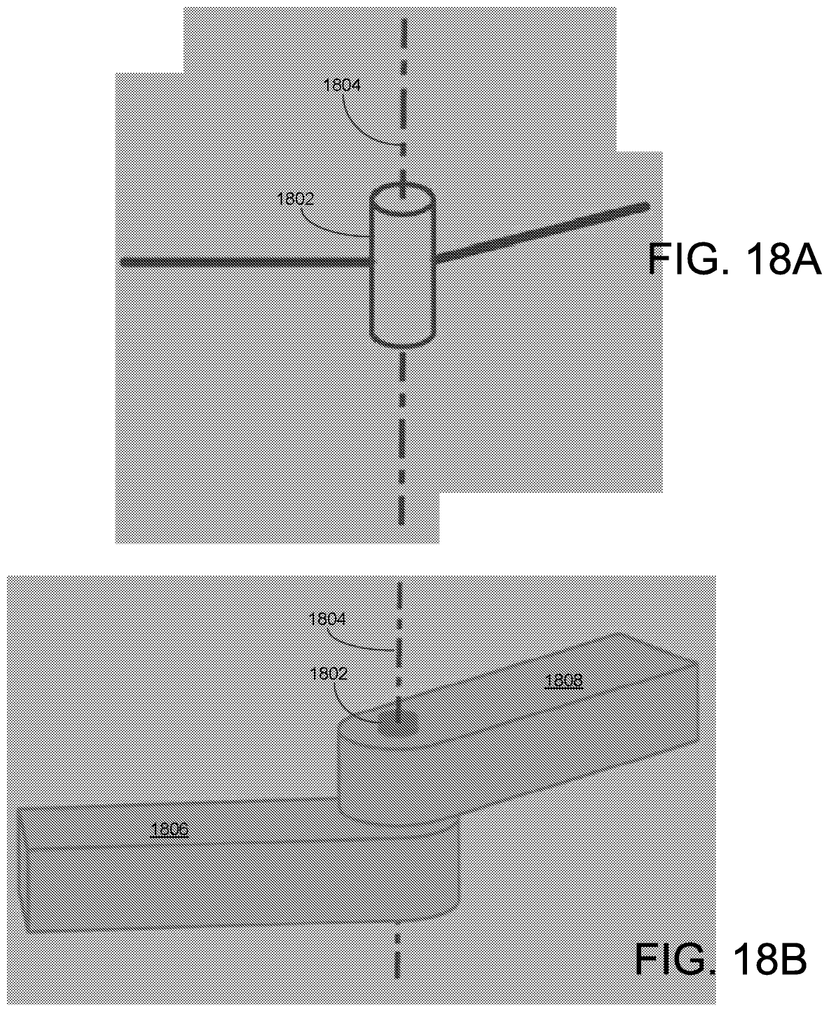

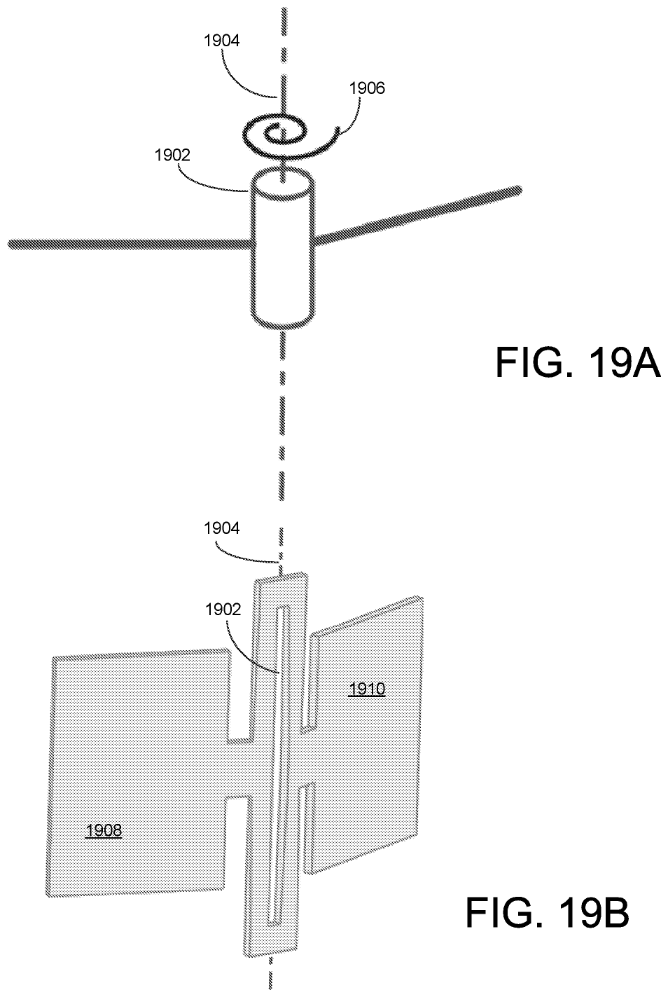

In some examples, the apparatus 100 can include the first joint 110, the second joint 112, the third joint 114, and the fourth joint 116. In some examples, the joints 110, 112, 114, 116 can have only a single degree of freedom. The joints 110, 112, 114, 116 can include traditional joints such as hinges (shown in FIG. 18B), or compliant joints such as flexure bearings (shown in FIG. 19B) and/or torsion springs. In the example of compliant joints, the joints can be biased to bring the links 110, 112, 114, 116 to the conformed position shown in FIG. 1A. While four links 102, 104, 106, 108 and four joints 110, 112, 114, 116 are shown in the example apparatus 100 of FIG. 1A, any number of four or more links and four or more joints can be included in the apparatus 100.

FIG. 1B shows the apparatus 100 of FIG. 1A in a deployed position. In this example, the links 102, 104, 106, 108 have rotated about the joints 110, 112, 114, 116 with respect to each other, and the first link 104, second link 106, and third link 108 no longer define the portion of the cylinder.

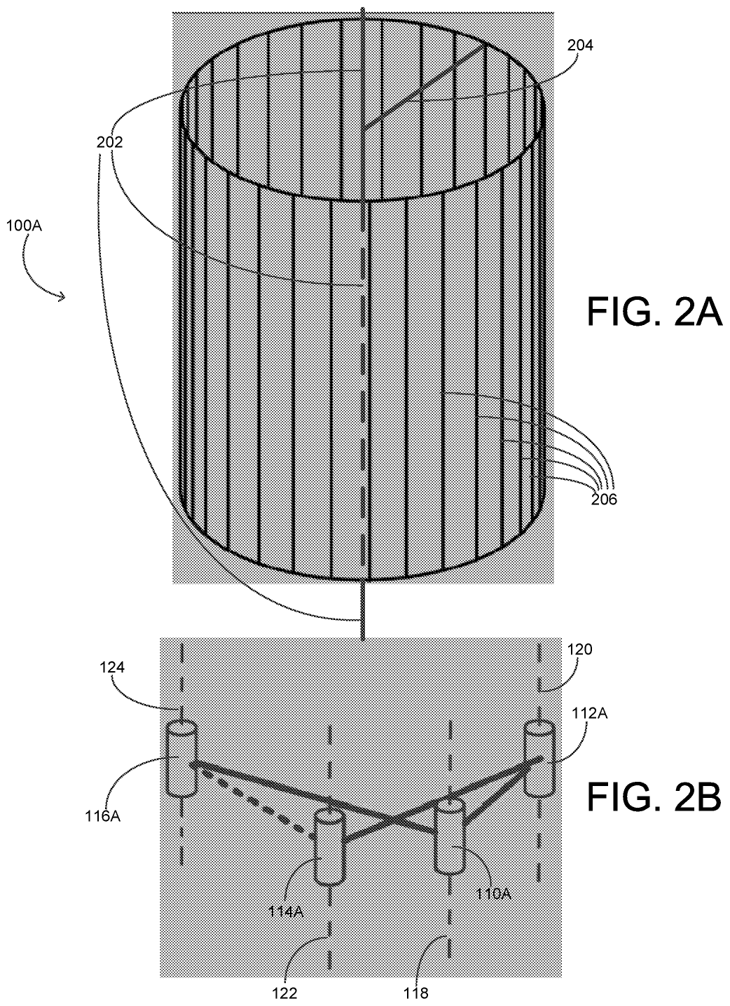

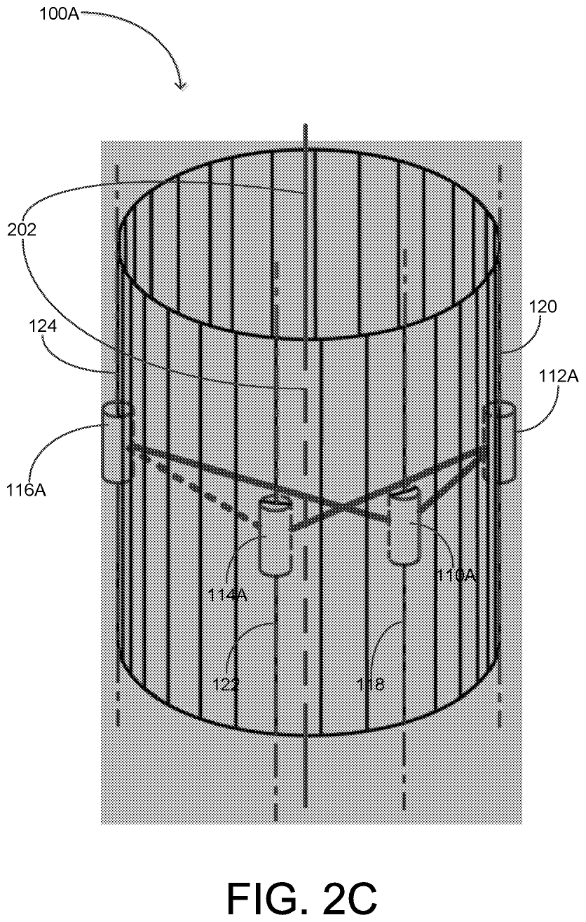

FIG. 1C shows joint axes 118, 120, 122, 124 of the apparatus 100 of FIG. 1A. The joint axes 118, 120, 122, 124 are shown in locations when the apparatus 100 is in the stowed position shown in FIG. 1A. A first joint axis 118 corresponds to the first joint 110, a second joint axis 120 corresponds to the second joint 112, a third joint axis 122 corresponds to the third joint 114, and a fourth joint axis 124 corresponds to the fourth joint 116. The joint axes 118, 120, 122, 124 are parallel to an axis of the cylinder defined by the links 102, 104, 106, 108. An example axis 202 is shown in FIGS. 2A and 2C.

FIG. 1D shows an apparatus 100 with multiple links 102, 104, 106, 108 in offset positions defining at least a portion of a cylinder in a stowed position. In this example, the apparatus 100 includes an offset base 102A to which the base link 102 is attached.

FIG. 1E shows the apparatus 100 of FIG. 1D in a deployed position. As shown in FIG. 1E, the offset base 102A prevents the links 104, 106, 108 from moving into the cylinder defined by the links 102, 106, 108, rendering the apparatus 100 extramobile, or capable only of exiting or remaining on the edge of the cylinder upon activation.

FIG. 1F shows joint axes 118, 120, 122, 124 of the apparatus 100 of FIG. 1D. FIG. 1F shows the offset(s) 125 of the joint axes 118, 120, 122, 124 from the offset base 102A.

FIG. 2A shows a schematic cylinder 100A with ruling lines 206. While a right or regular circular cylinder is shown in FIG. 2A, in which a top and bottom (if present) would form right angles with the sides, the techniques and features described herein can be applied to generalized cylinders in which the top and bottom do not form right angles with the sides, and/or in which the top and bottom form ellipses that are not circular, such as an oblique circular cylinder and/or an oblique elliptical cylinder. While only five of the ruling lines 206 are labeled in FIG. 2A for ease of illustration, all of the vertical lines in FIG. 2A other than the axis 202 may be considered ruling lines 206. The ruling lines 206 extend along the surface of the schematic cylinder 100A and are parallel to each other and to an axis 202 of the schematic cylinder 100A. The axis 202 extends through a center of the schematic cylinder 100A. A radius of curvature of the schematic cylinder 100A is equal to a length of a radius 204 of the schematic cylinder 100A. The radius 204 extends from the axis 202 to the surface of the schematic cylinder 100A.

When the links 102, 104, 106, 108 of the apparatus 100 shown in FIG. 1 are in the stowed position, the links 102, 104, 106, 108 can all have a same radius of curvature as each other and/or as a schematic cylinder 100A. When the links 102, 104, 106, 108 of the apparatus 100 shown in FIG. 1 are in the stowed position, the links 102, 104, 106, 108 can define a portion of the schematic cylinder 100A. When the links 102, 104, 106, 108 of the apparatus 100 shown in FIG. 1 are in the stowed position, the axes of the joints 110, 112, 114, 116 can extend along ruling lines 206 of the schematic cylinder 100A of which the links 102, 104, 106, 108 define a portion.

FIG. 2B shows joint axes 118, 120, 122, 124 aligned with the ruling lines 206 shown in FIG. 2A. The joint axes 118, 120, 122, 124 can extend from schematic joints 110A, 112A, 114A, 116A. The schematic joints 110A, 112A, 114A, 116A can correspond to the joints 110, 112, 114, 116, respectively. The locations of the schematic joints 110A, 112A, 114A, 116A can correspond to the locations of the joints 110, 112, 114, 116, respectively, when the apparatus 100 is in the stowed position.

FIG. 2C shows the joint axes 118, 120, 122, 124 of FIG. 2B in the schematic cylinder 100A of FIG. 2A. As shown in FIG. 2C, the joint axes 118, 120, 122, 124 extend along ruling lines 206 (not labeled in FIG. 2C) of the schematic cylinder 100A. The schematic joints 110A, 112A, 114A, 116A can be considered to represent the joints 110, 112, 114, 116 of the apparatus 100 of FIG. 1A in the stowed position. With the apparatus 100 in the stowed position and the joints 110, 112, 114, 116 in the locations of the schematic joints 110A, 112A, 114A, 116A and the links 102, 104, 106, 108 having the same radius of curvature as the schematic cylinder 100A, the links 102, 104, 106, 108 would extend along the surface of the schematic cylinder 100A and/or define a portion of the schematic cylinder 100A.

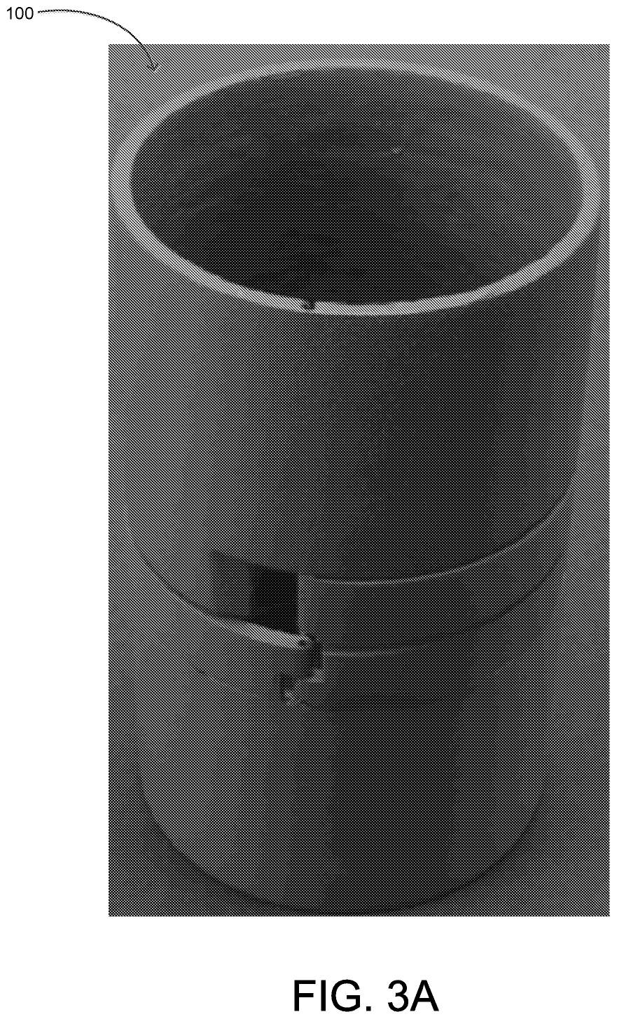

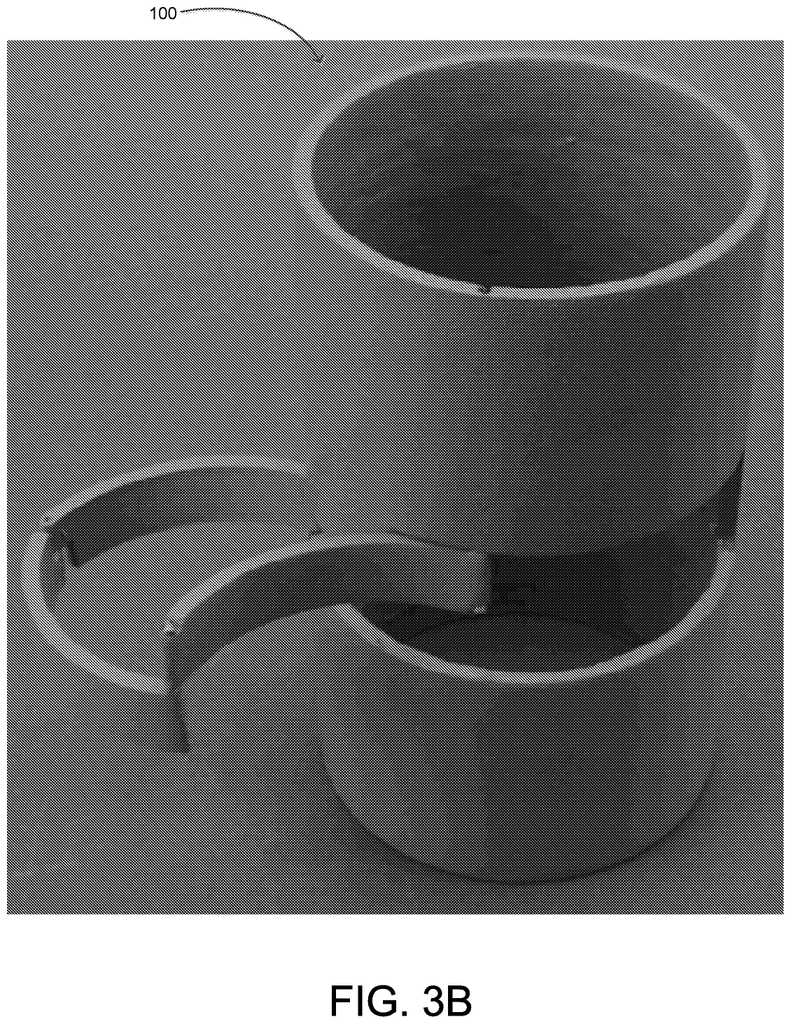

FIG. 3A shows an apparatus 100 with multiple links defining at least a portion of a cylinder in a stowed position. The links (not labeled in FIG. 2D) can correspond to the links 102, 104, 106, 108 shown and labeled in FIG. 1A.

FIG. 3B shows an apparatus 100 with multiple links defining at least a portion of a cylinder in a deployed position. In this example, the links have rotated with respect to each other out of the stowed position, so that some of the links no longer define the portion of the cylinder (the links may define portions of different cylinders), into the deployed position.

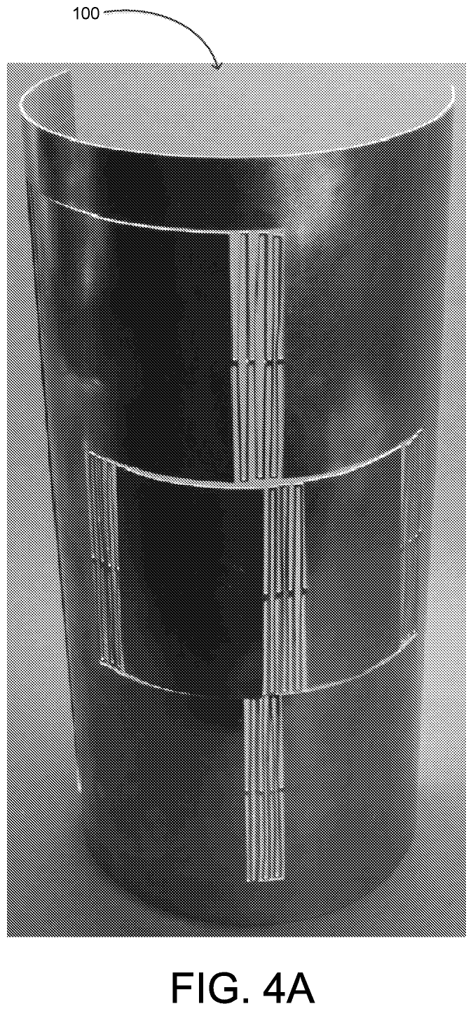

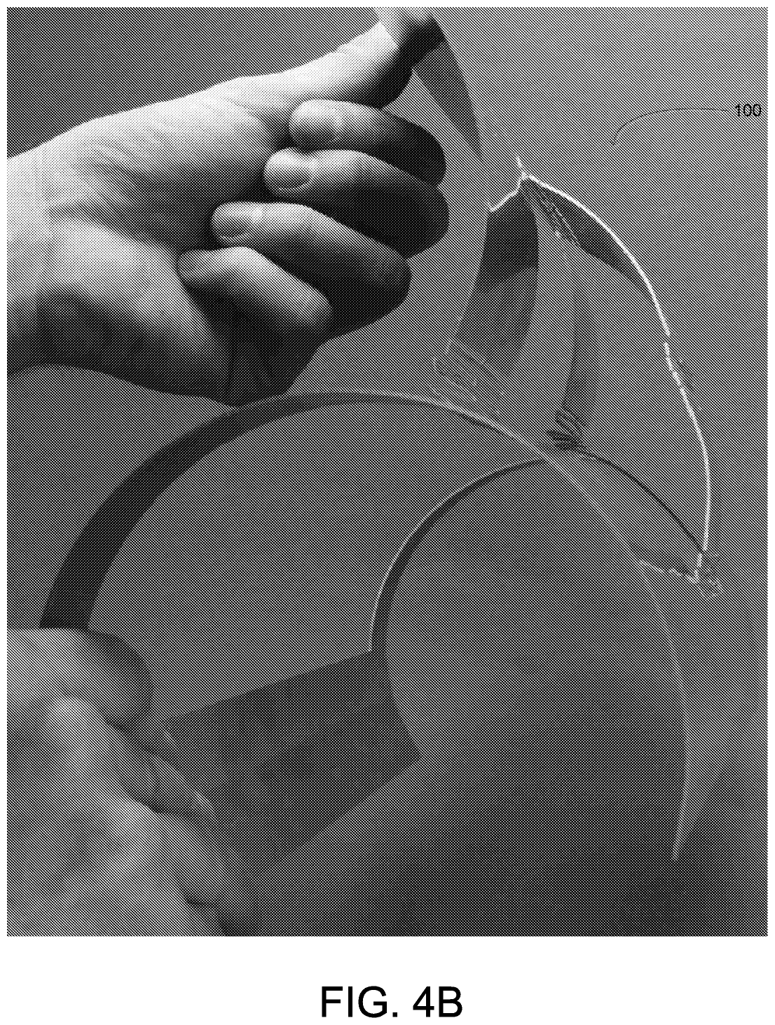

FIG. 4A shows an apparatus 100 with multiple links defining at least a portion of a cylinder in a stowed position. The links (not labeled in FIG. 3A) can correspond to the links 102, 104, 106, 108 shown and labeled in FIG. 1A. In this example, portions of a sheet have been cut out and/or removed to form flexure bearing joints and/or living hinges.

FIG. 4B shows an apparatus 100 with multiple links defining at least a portion of a cylinder in a deployed position. In this example, the links have rotated with respect to each other out of the stowed position, so that some of the links no longer define the portion of the cylinder (the links may define portions of different cylinders), into the deployed position.

FIG. 5A shows an apparatus 100 with multiple links defining at least a portion of a cylinder with a rotation mechanism 502 in a stowed position. The links (not labeled in FIG. 5A) can correspond to the links 102, 104, 106, 108 shown and labeled in FIG. 1A. The rotation mechanism 502 can include, for example, an electric motor and belt, band, or other mechanism coupling the motor to one or more of the joints (which are not labeled in FIG. 5A and can correspond to the joints 110, 112, 114, 116 of FIG. 1A) of the apparatus 100. The rotation mechanism 502 can cause one or more of the joints to rotate, and/or cause at least two of the links to rotate with respect to each other. In some examples, the rotation mechanism can also cause an outer cylinder with the links and joints described herein to rotate with respect to an inner cylinder.

FIG. 5B shows the apparatus 100 of FIG. 5A in the stowed position. FIG. 5B shows the rotation mechanism 502 including a belt or band coupled to a joint.

FIG. 5C shows the apparatus of FIGS. 5A and 5B in the stowed position. FIGS. 5C and 5D show the example rotation mechanism including a motor and band or belt controlling a joint.

FIGS. 5D, 5E, and 5F show the apparatus of FIGS. 5A, 5B, and 5C in deployed positions. In these examples, the rotation mechanism 502 has caused a joint to rotate, moving the links out of the stowed position and into various deployed positions.

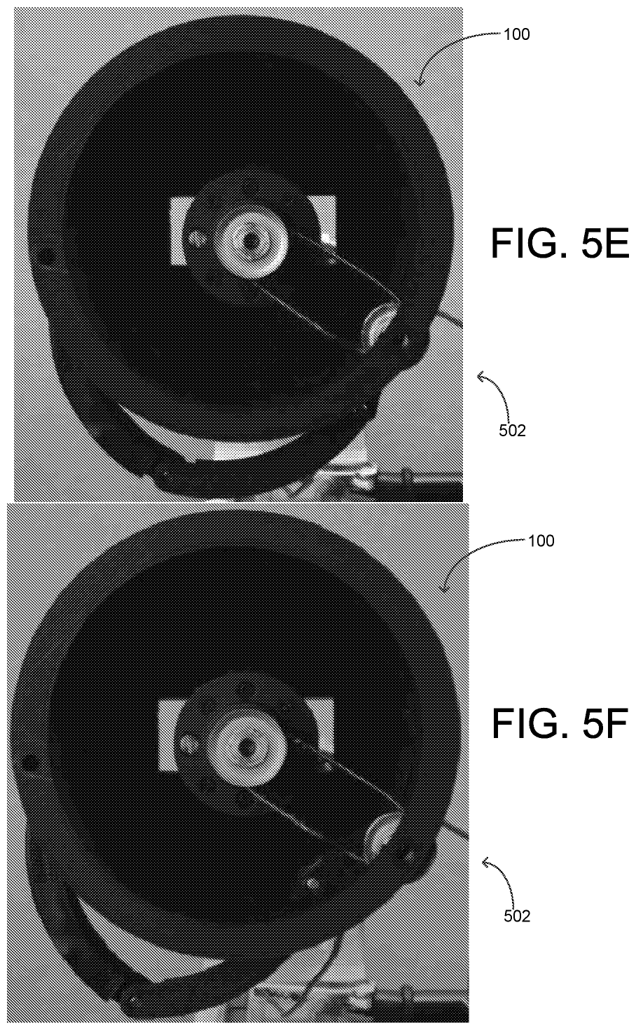

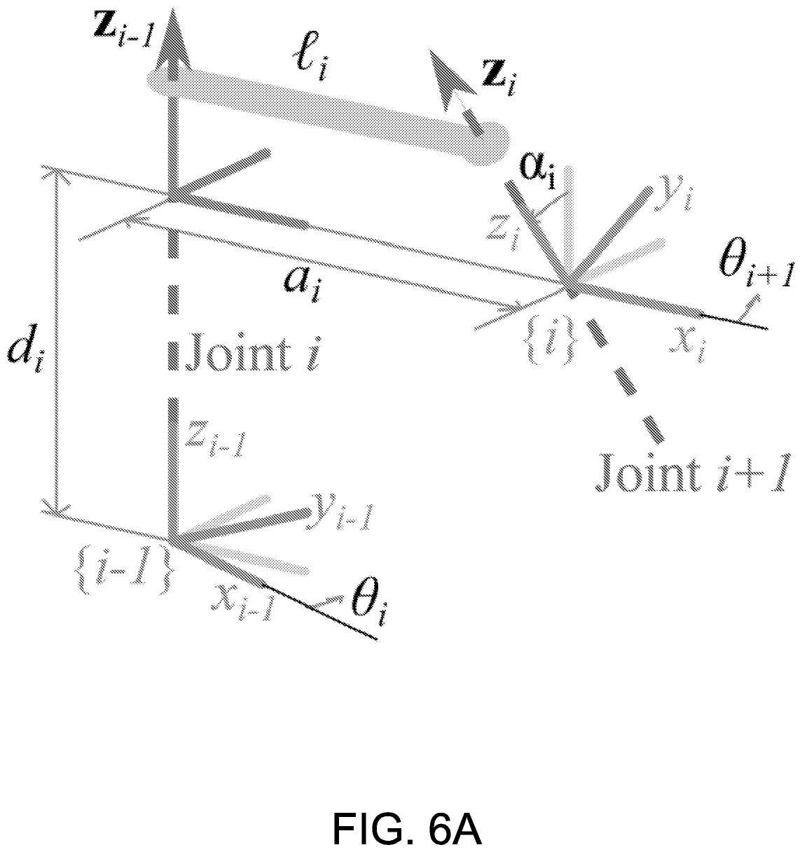

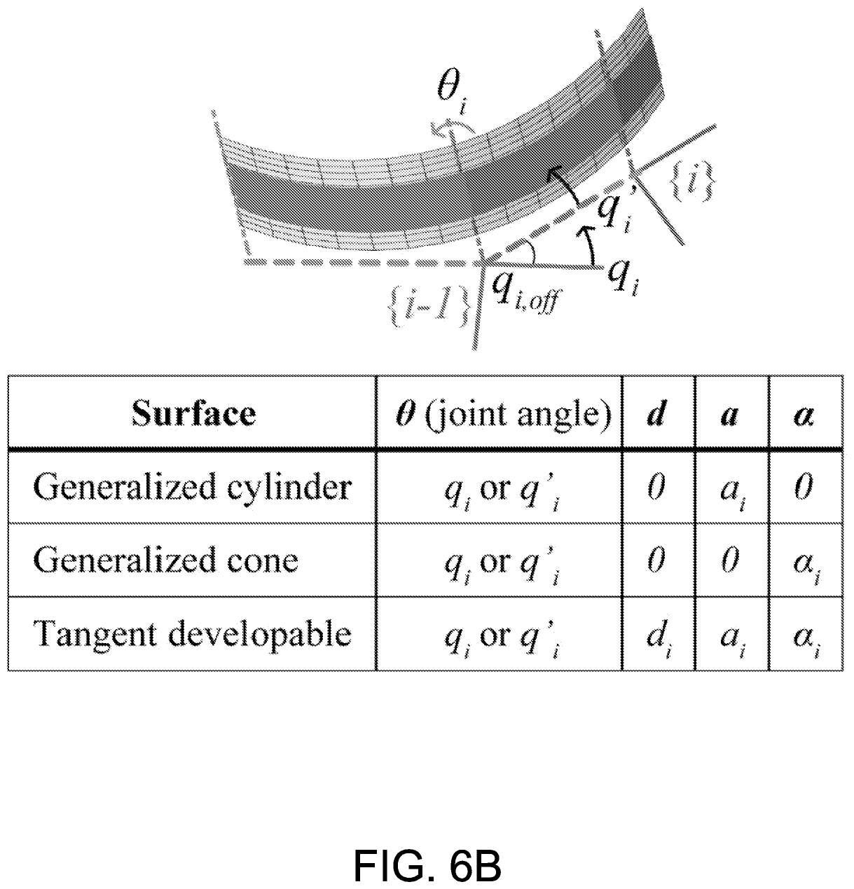

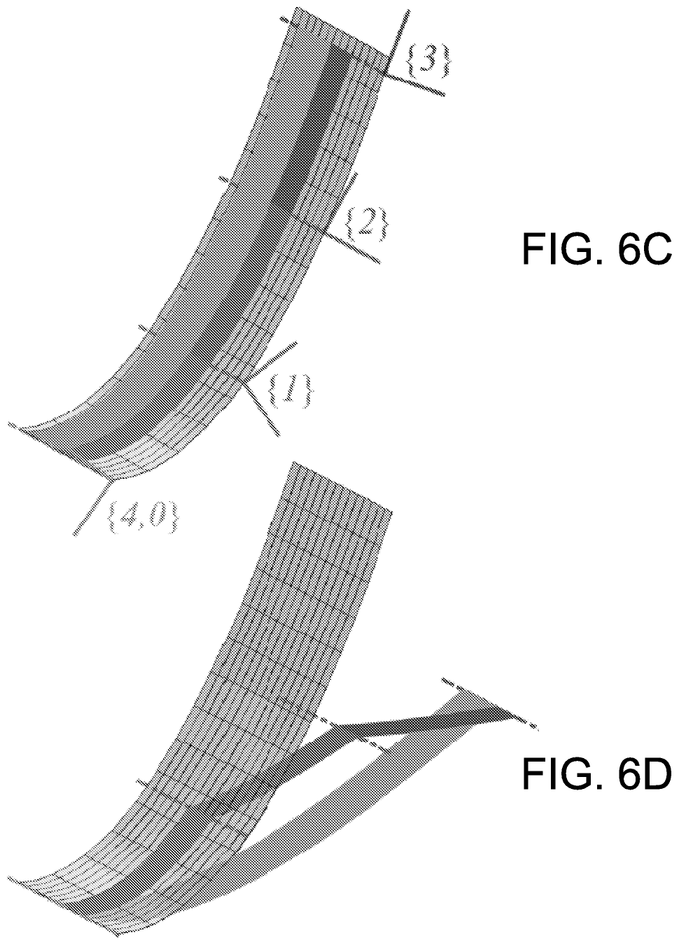

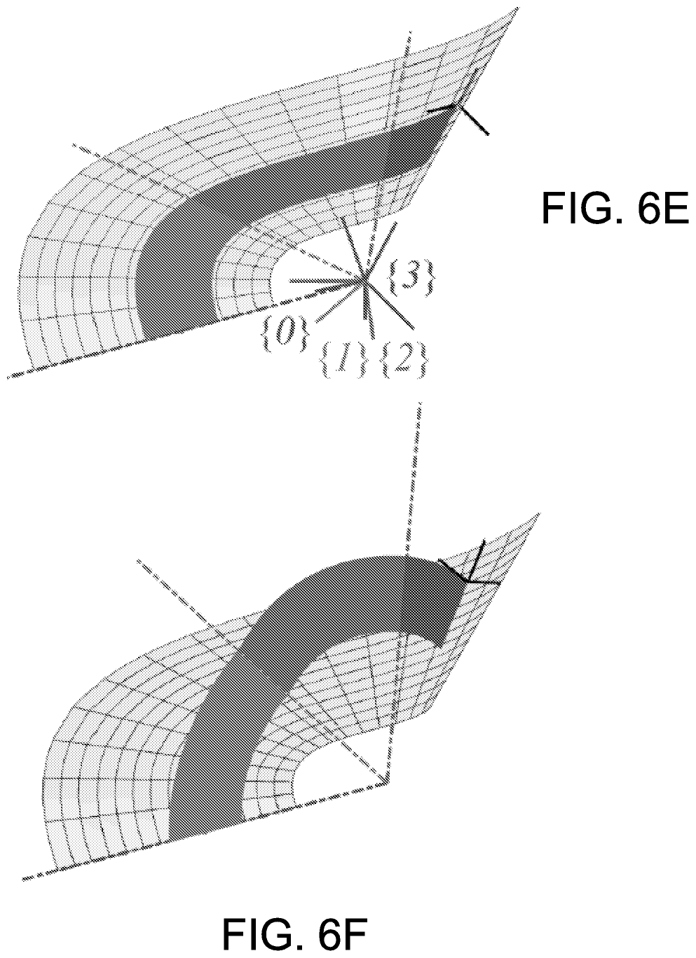

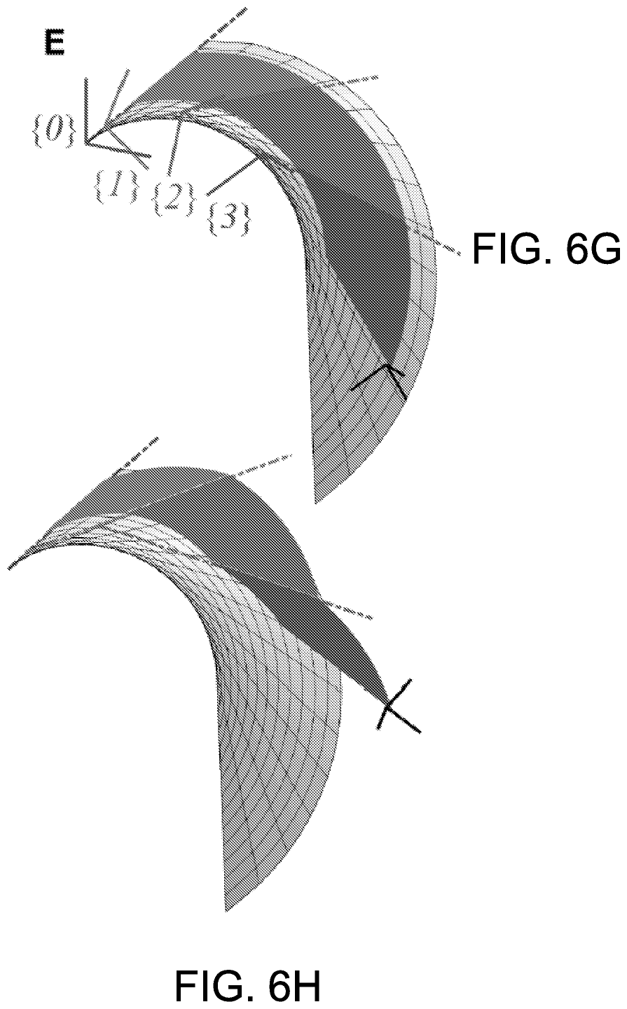

FIGS. 6A, 6B, 6C, 6D, 6E, 6F, 6G; and 6H show Denavit-Hartenberg (DH) parameters for mechanisms described herein. FIG. 6A shows the DH parameter notation. FIG. 6B illustrates introduction of an offset q_{i,off} at the ith revolute joint to change the zero angle reference position from the qᵢ axis to the q′ᵢ axis, resulting in the zero angle position of the mechanism being the position where the links conform with the surface. The table shows which DH parameters are zero for each type of developable surface (cones and tangent developable surfaces are discussed below).

FIGS. 6C and 6D show DH frames on a closed-loop 4R developable mechanism in a conforming or stowed position (FIG. 6C) and an actuated or deployed position (FIG. 6D). FIGS. 6E and 6F show DH frames on an open 3R chain conical developable mechanism in a conforming or stowed position (FIG. 6E) and an actuated or deployed position (FIG. 6F). FIGS. 6G and 6H show DH frames on an open 3R chain tangent developable mechanism in a conforming or stowed position (FIG. 6G) and an actuated or deployed position (FIG. 6H). FIGS. 6E, 6F, 6G and 6H show a possible tool frame at the end of the chain.

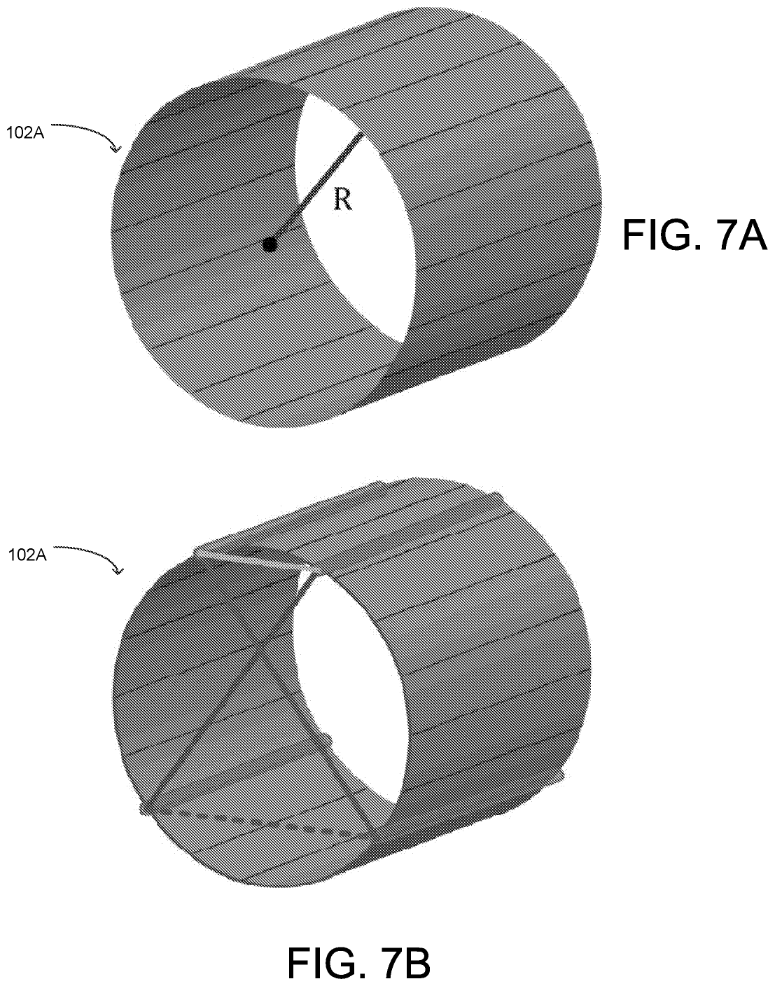

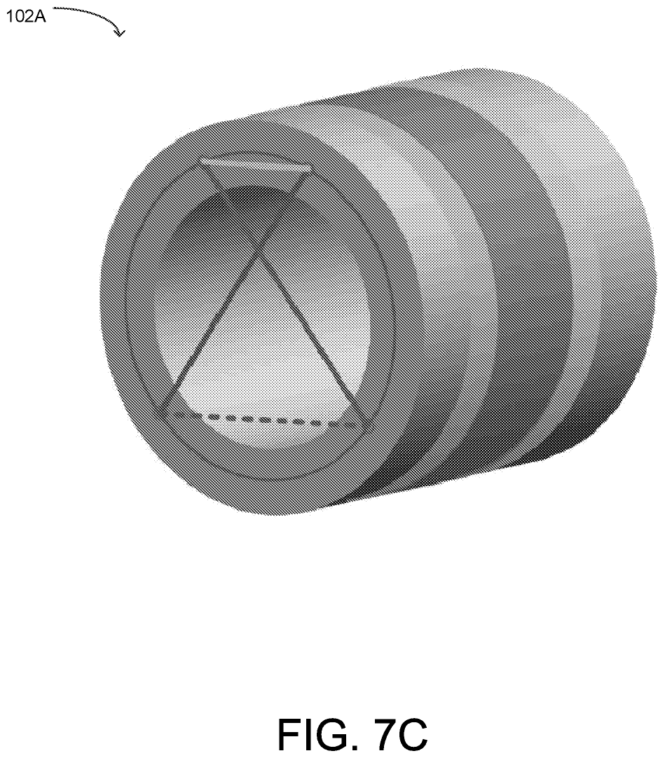

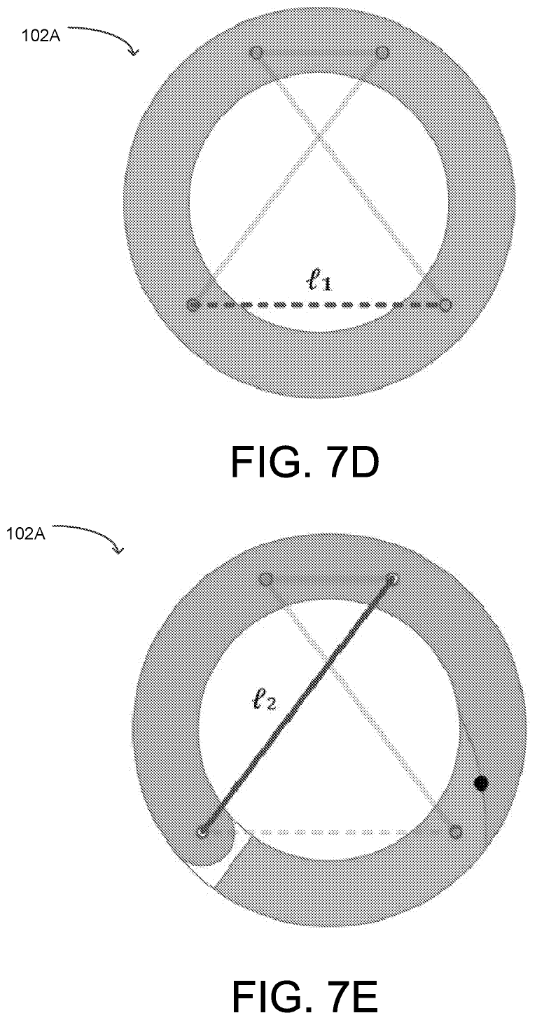

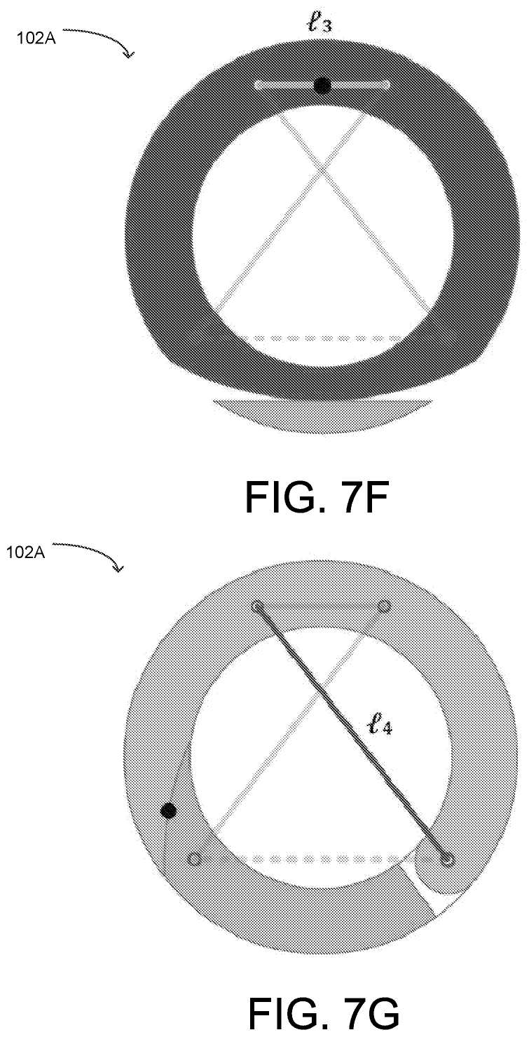

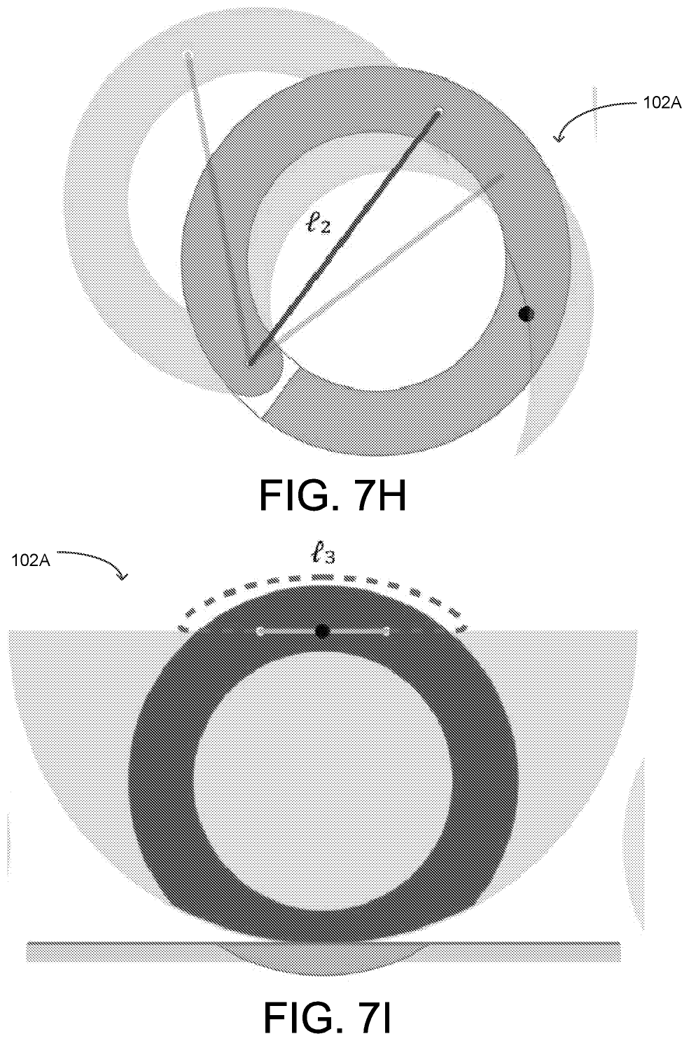

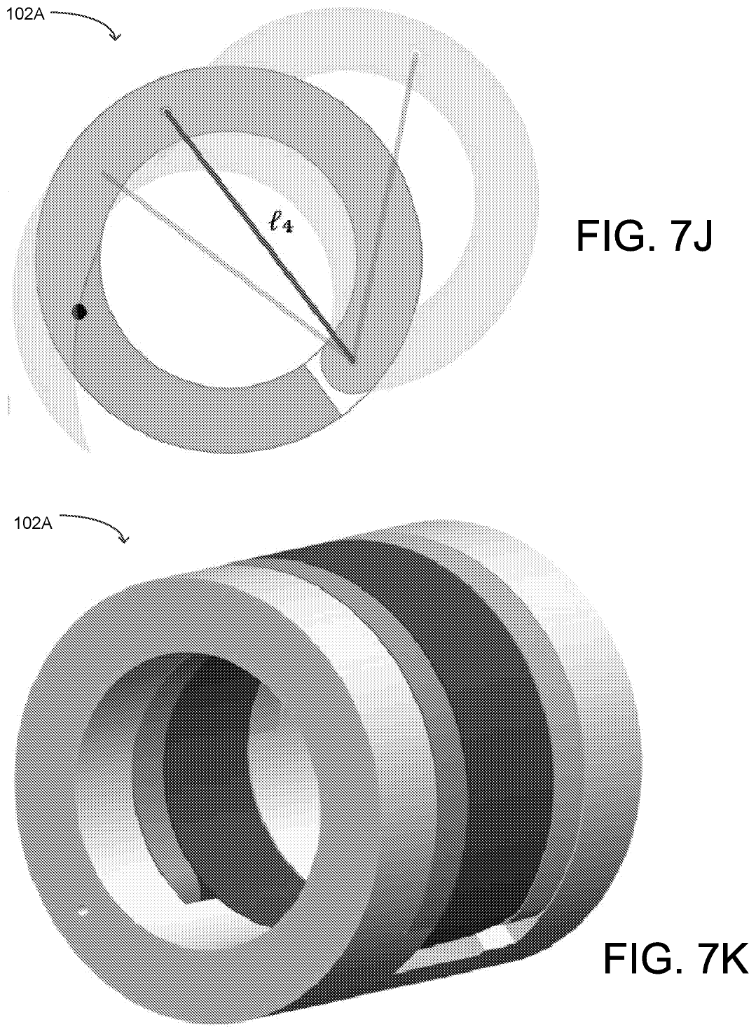

FIGS. 7A, 7B, 7C, 7D, 7E, 7F, 7G, 7H, 7I, 7J, 7K show creating a mechanism described herein. FIGS. 7A, 7B, 7C, 7D, 7E, 7F, 7G, 7H, 7I, 7J, 7K show creating a developable mechanism using a Chebyshev straight line mechanism integrated with a cylinder. FIG. 7A shows a cylinder with radius R selected as the base surface for a Chebyshev mechanism. FIG. 7B shows ruling lines that will serve as joint axes and a corresponding linkage skeleton. A ground link (which may correspond to the base link 102) is shown with a dashed line, and remaining links are shown with solid lines. FIG. 7C shows applied thickness and selected link layers on the surface of the cylinder. FIGS. 7D, 7E, 7F, and 7G show geometry of each of the link layers and corresponding skeleton links. FIGS. 7H, 7I, and 7J show a process for defining link geometries. FIG. 7K shows a computer-aided design (CAD) model of the developable mechanism, which can be an example of the apparatus 100.

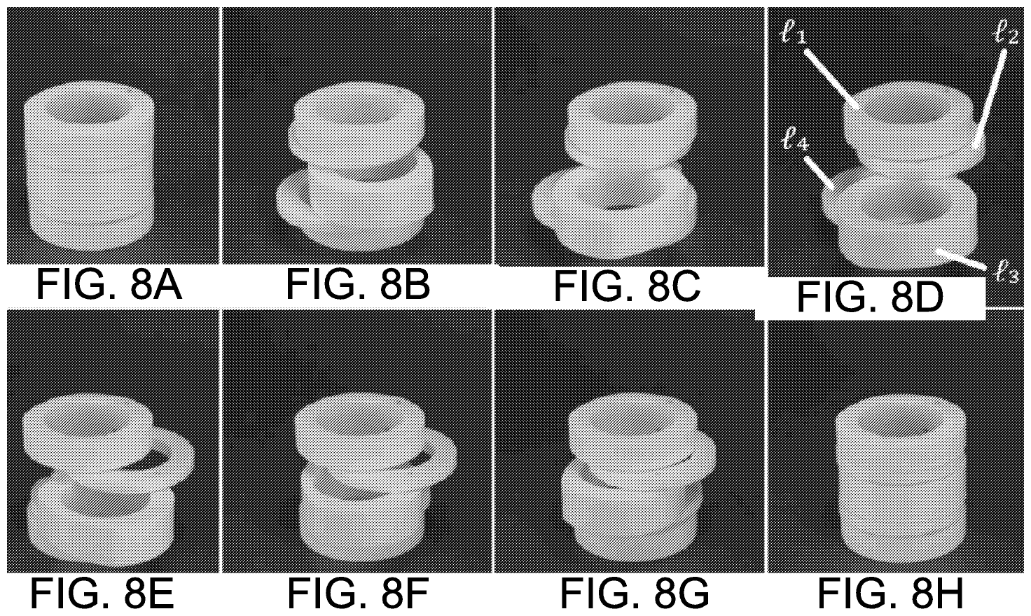

FIGS. 8A, 8B, 8C, 8D, 8E, 8F, 8G; and 8H show motion of links of an apparatus with multiple links defining at least a portion of a cylinder. The labels l₁, l₂, l₃, and l₄ correspond to the labels shown in FIGS. 7D, 7E, 7F, 7G; 7H, 7I, and 7J. The apparatus can be an example of the apparatus 100.

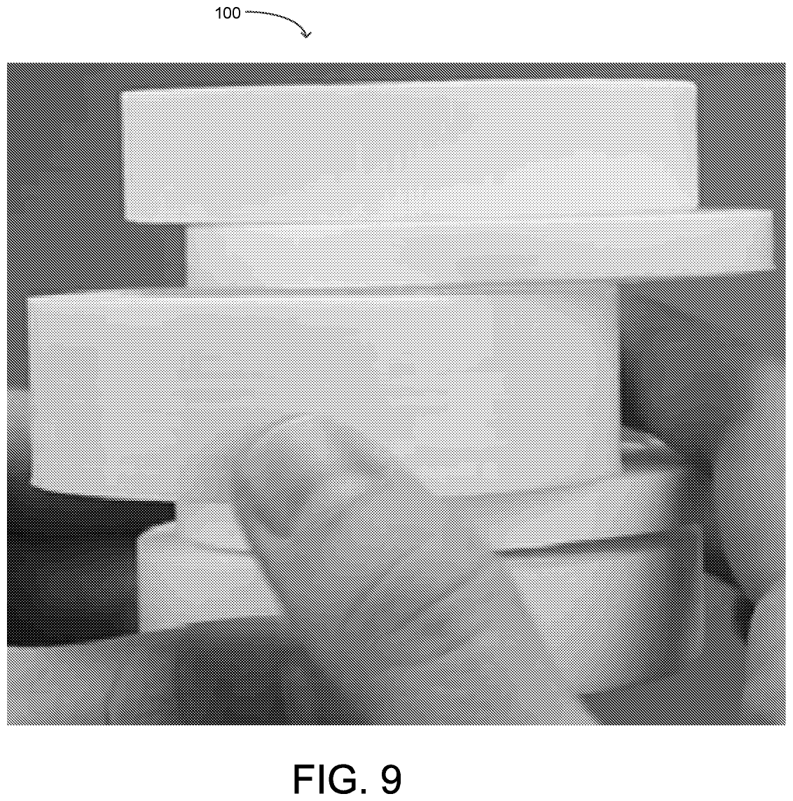

FIG. 9 shows an apparatus 100 with multiple links defining at least a portion of a cylinder in a deployed position. The links can be moved with respect to each other via joints.

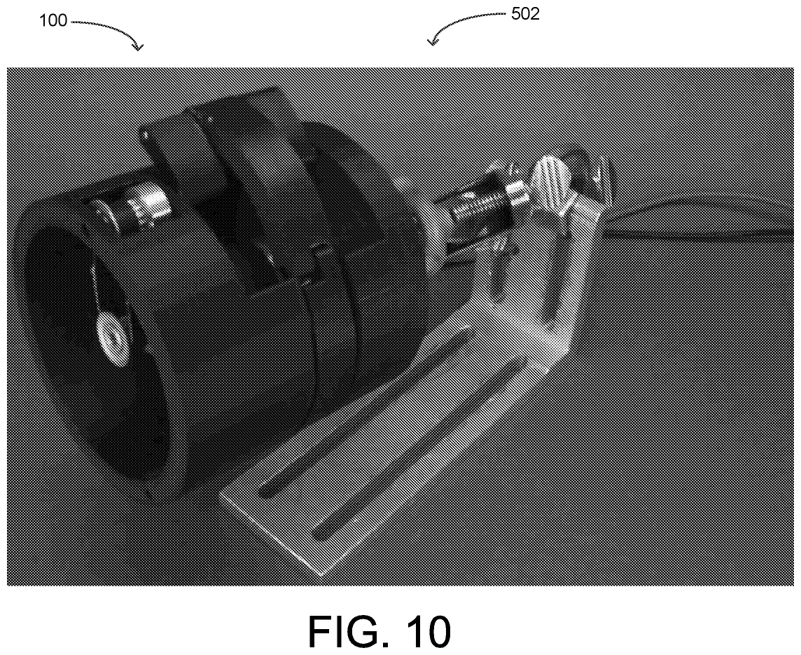

FIG. 10 shows an apparatus 100 with multiple links defining at least a portion of a cylinder with a rotation mechanism in a deployed position. A rotation mechanism 502, which can include an electric motor controlling a belt, the belt being coupled to at least one of the joints, can control movement of the links.

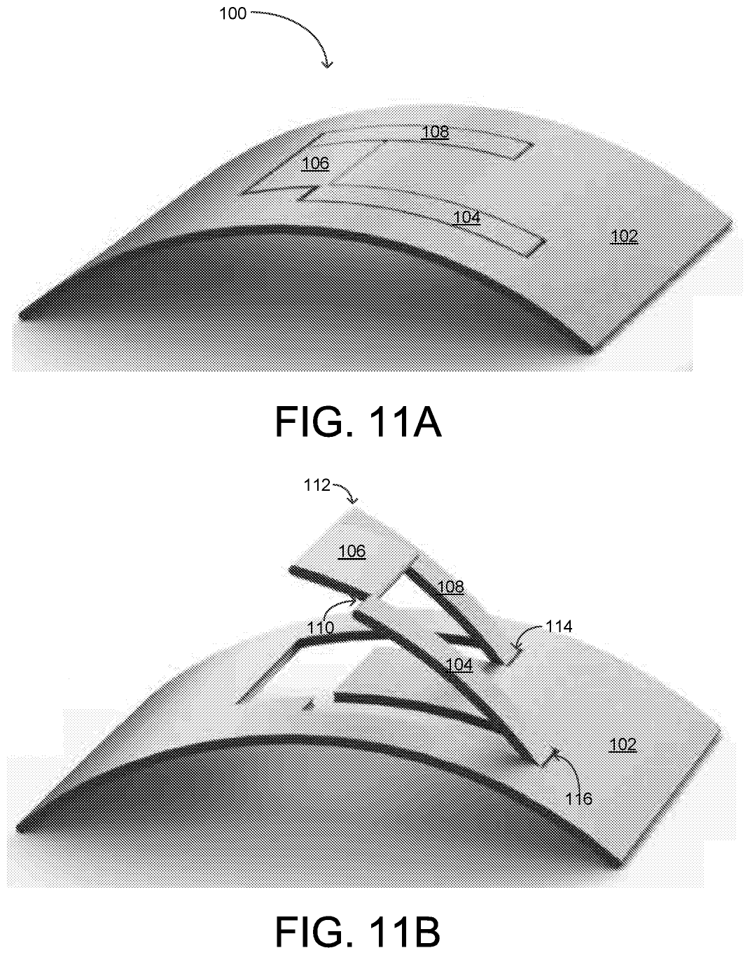

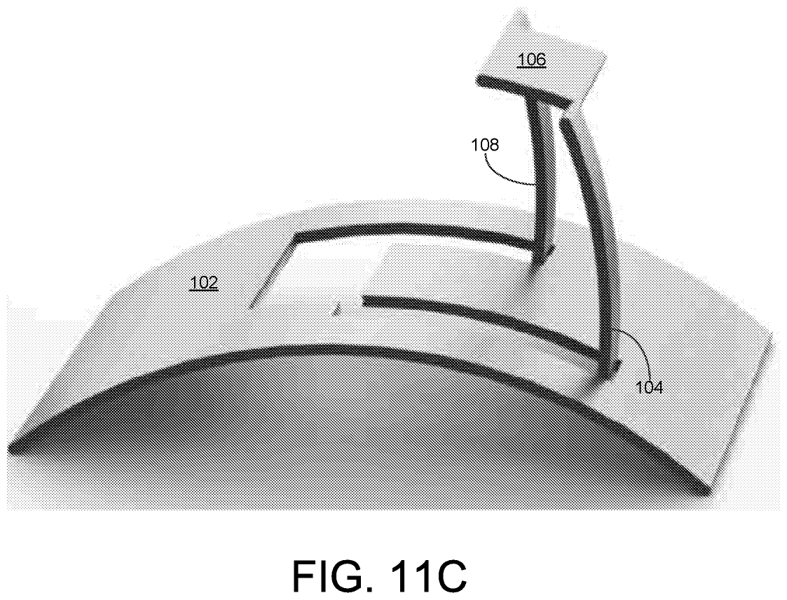

FIG. 11A shows an apparatus 100 with multiple links 102, 104, 106, 108 defining at least a portion of a cylinder in a stowed position. The links 102, 104, 106, 108 can correspond to the links 102, 104, 106, 108 shown and described above with respect to FIG. 1A.

FIG. 11B shows the apparatus 100 of FIG. 11A in a deployed position. The links 102, 104, 106, 108 have rotated with respect to each other via joints 112, 112, 114, 116. The joints 112, 112, 114, 116 can correspond to the joints 112, 112, 114, 116 described above with respect to FIG. 1A.

FIG. 11C shows the apparatus 100 of FIGS. 11A and 11B in a deployed position. FIG. 11C shows the first link 104, second link 106, and third link 108 having moved further with respect to the base link 102.

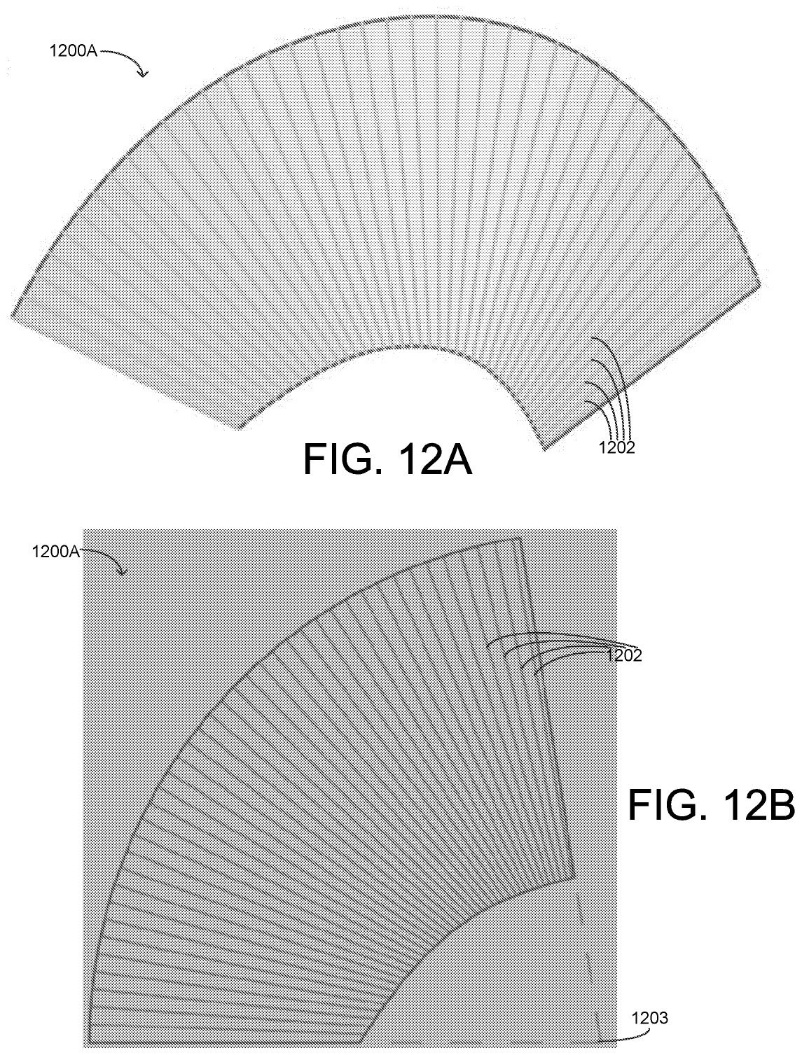

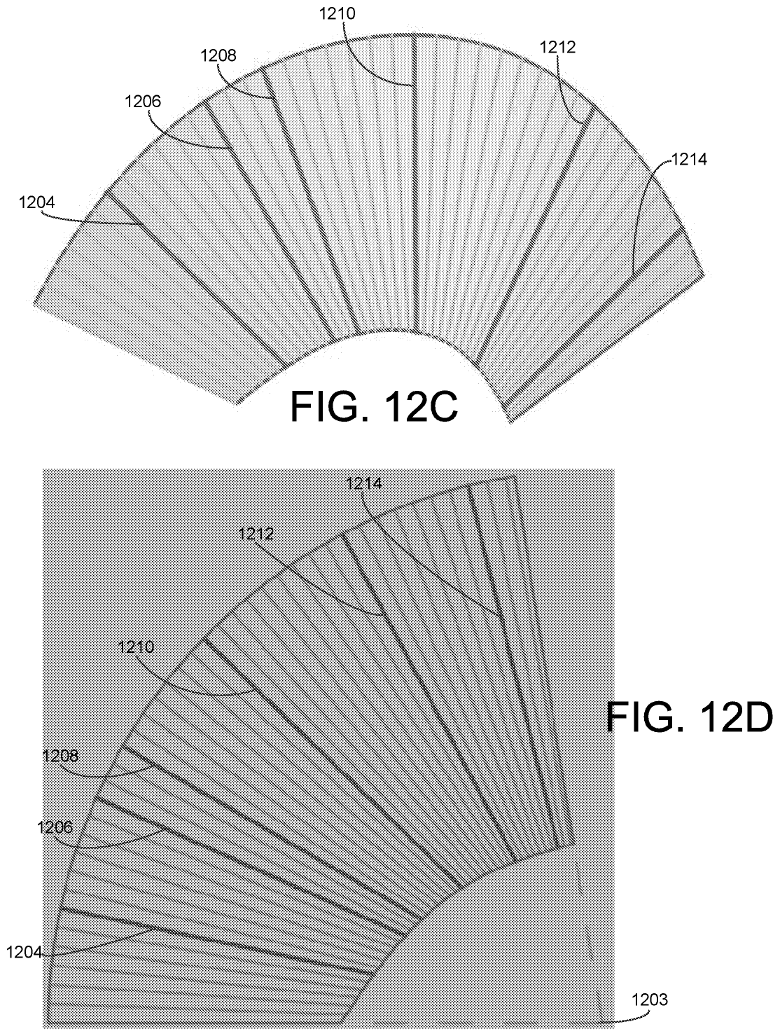

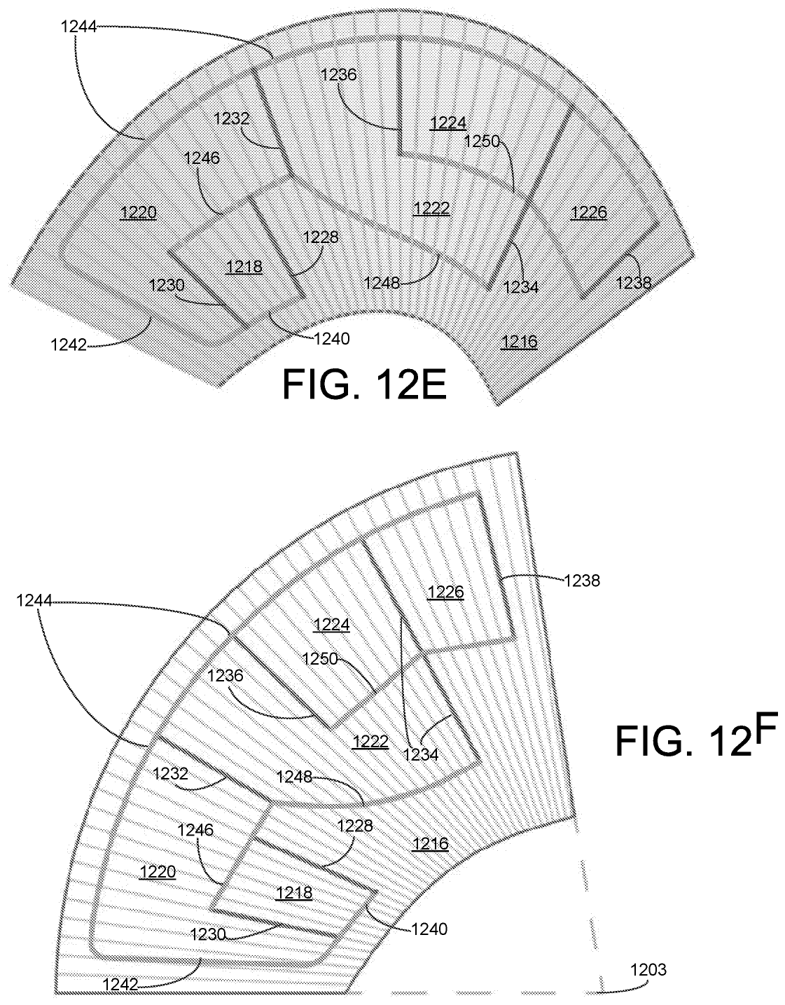

FIG. 12A shows a schematic portion 1200A of a three-dimensional cone with ruling lines 1202. While only four ruling lines 1202 are labeled in FIG. 12A, the schematic portion 1200A of the three-dimensional cone can have any number of ruling lines 1202. If extended, the ruling lines 1202 would extend through an apex of the cone.

FIG. 12B shows a schematic portion 1200A of a two-dimensional cone with ruling lines 1202. The schematic portion 1200A shown in FIG. 12B can be a portion of the same cone as shown in FIG. 12A, shown in two dimensions rather than three (as in FIG. 12A). While only four ruling lines 1202 are labeled in FIG. 12B, the schematic portion 1200A of the two-dimensional cone can have any number of ruling lines 1202. If extended, the ruling lines 1202 would extend through an apex of the cone.

FIG. 12C shows joint axes 1204, 1206, 1208, 1210, 1212, 1214 aligned with the ruling lines 1202 (not labeled in FIG. 12C) of FIG. 12A. If extended, the joint axes 1204, 1206, 1208, 1210, 1212, 1214 would extend through the apex of the cone.

FIG. 12D shows joint axes 1204, 1206, 1208, 1210, 1212, 1214 aligned with the ruling lines 1202 (not labeled in FIG. 12D) of FIG. 12B. If extended, the joint axes 1204, 1206, 1208, 1210, 1212, 1214 would extend through the apex 1203 of the cone.

FIG. 12E shows links 1216, 1218, 1220, 1222, 1224, 1226 in the cone of FIG. 12A. FIG. 12F shows links 1216, 1218, 1220, 1222, 1224, 1226 in the cone of FIG. 12B.

In some examples, the links 1216, 1218, 1220, 1222, 1224, 1226 can include a base link 1216, a first link 1218, a second link 1220, and a third link 1222. The first link 1218 can be hingedly coupled to the second link 1220 via a first joint 1230. The second link 1220 can be hingedly coupled to the third link 1222 via a second joint 1232. The third link 1222 can be hingedly coupled to the base link 1216 via a third joint 1234. The base link 1216 can be hingedly coupled to the first link via a fourth joint 1228.

In some examples, the links 1216, 1218, 1220, 1222, 1224, 1226 can include the base link 1216, the first link 1218, the second link 1220, the third link 1222, a fourth link 1224, and a fifth link 1226. The first link 1218 can be hingedly coupled to the second link 1220 via the first joint 1230. The second link 1220 can be hingedly coupled to the third link 1222 via the second joint 1232. The third link 1222 can be hingedly coupled to the base link 1216 via the third joint 1234. The base link 1216 can be hingedly coupled to the first link via the fourth joint 1228. The third link 1222 can be hingedly coupled to the fourth link via a fifth joint 1236. The fourth link 1224 can be hingedly coupled to the fifth link 1226 via a sixth joint 1234 (which can share a joint axis with and/or be considered a same joint as the third joint 1234). The fifth link 1226 can be hingedly coupled to the base link via a seventh joint 1238. In this example, the base link 1216 can be considered a tertiary link, coupling to three other links, namely the first link 1218, the third link 1222, and the fifth link 1226, and/or connecting three hinge axes or joint axes. Also in this example, the third link 1222 can be considered a tertiary link, coupling to three other links, namely the second link 1220, the fourth link 1224, and the base link 1216, and/or connecting three hinge axes or joint axes. In some examples, cylinders can include tertiary links with couplings between links and joints as described in this paragraph.

In the stowed, conforming, and/or closed position shown in FIGS. 12E and 12F, the joints 1228, 1230, 1232, 1234, 1236, 1238 extend along the joint axes 1204, 1206, 1208, 1210, 1212, 1214 shown in FIGS. 12C and 12D, and/or point toward the apex 1203 of a cone partially defined by the links 1216, 1218, 1220, 1222, 1224, 1226. The first joint 1228 can be closer to the third joint 1232 than to the second joint 1230.

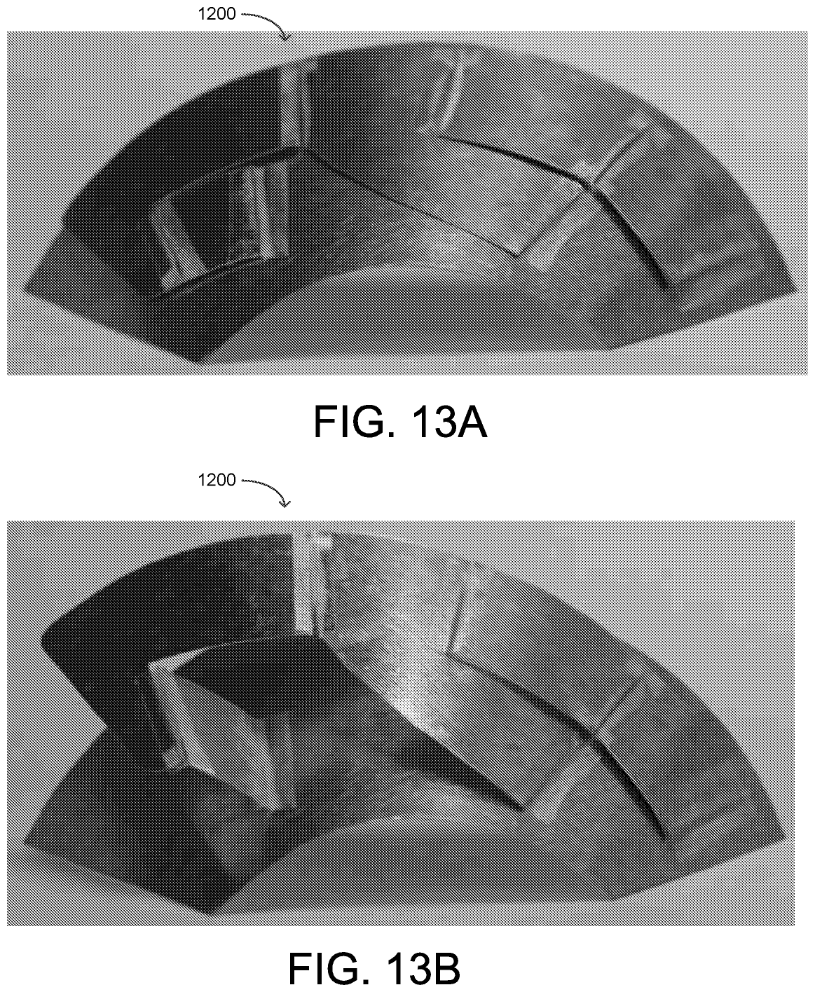

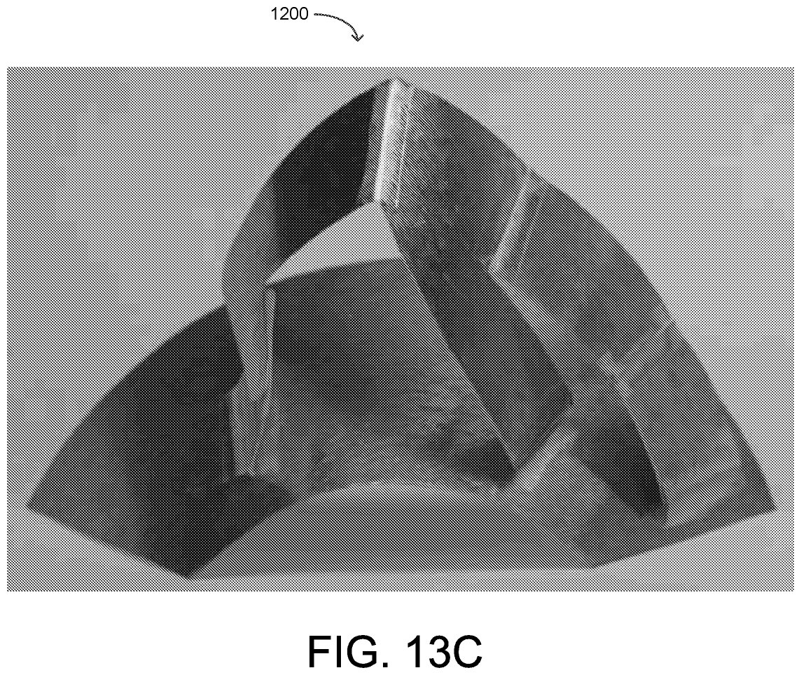

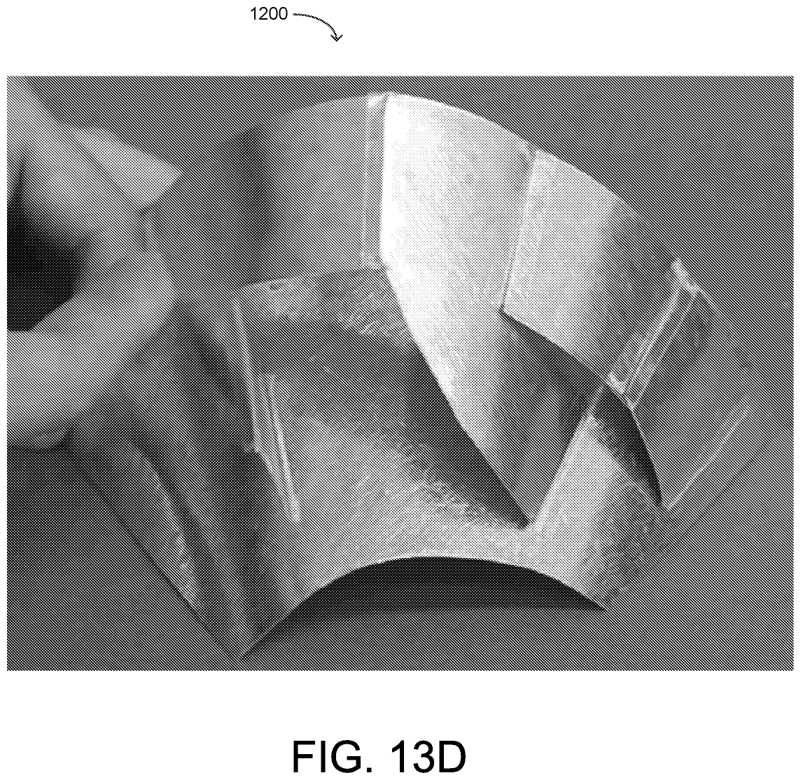

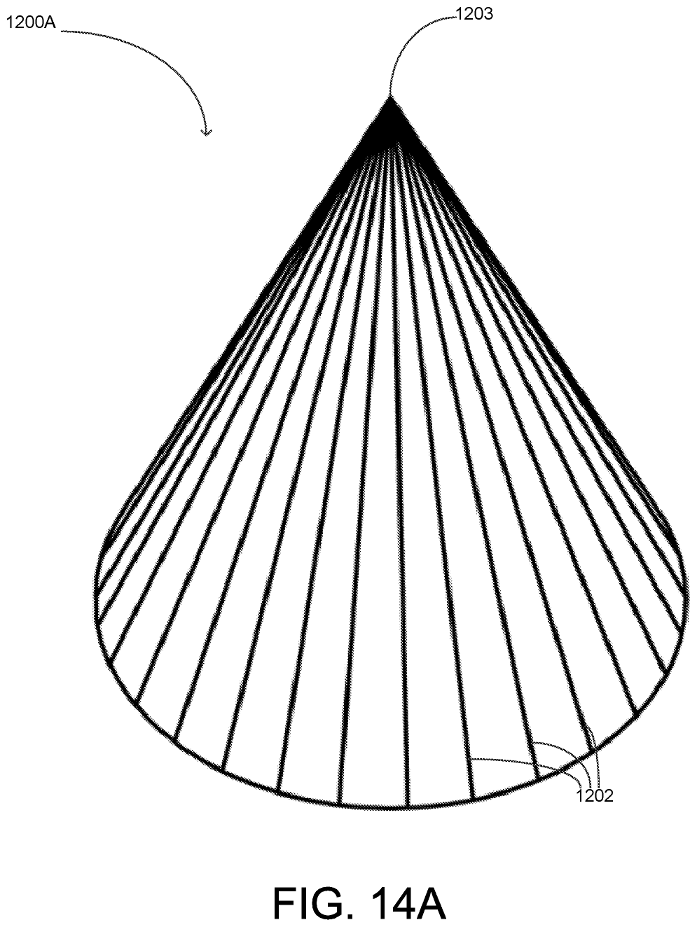

FIG. 13A shows an apparatus 1200 with multiple links defining at least a portion of a cone in a stowed position. The apparatus 1200 is an implementation of the schematic diagrams shown in FIGS. 12A, 12B, 12C, 12D, 12E, and 12F. While not labeled in FIG. 13A, the links and joints correspond to the links 1216, 1218, 1220, 1222, 1224, 1226 and joints 1228, 1230, 1232, 1234, 1236, 1238 shown in FIGS. 12E and 12F. In this stowed, conformed, and/or closed position, the multiple links define a portion or a cone, and the joints point toward an apex of the cone. The links 1216, 1218, 1220, 1222, 1224, 1226 can comprise rigid sheets, such as metal or plastic.

FIGS. 13B, 13C, and 13D shows the apparatus 1200 of FIG. 13A in a deployed position. In this deployed, actuated, and/or open position, at least two of the links no longer define the portion of the cone. In this deployed, actuated, and/or open position, the axes of the joints still point toward the apex 1203 of the cone. A rotation mechanism can rotate at least two of the links with respect to each other.

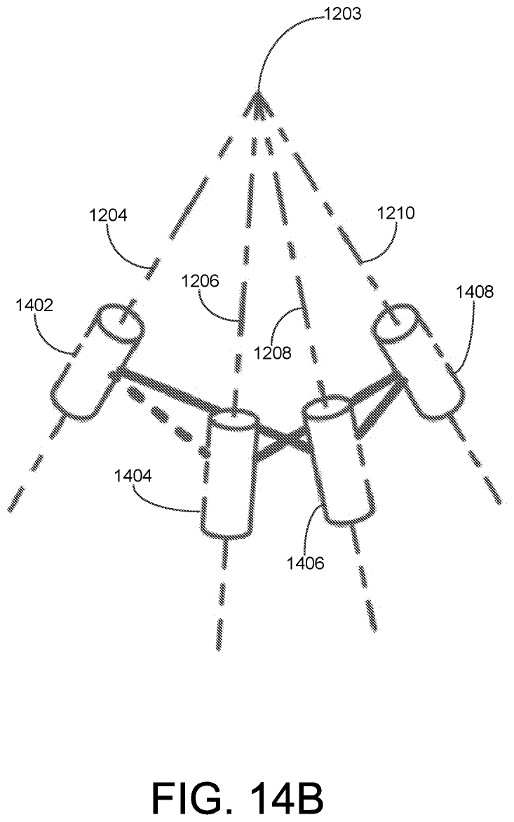

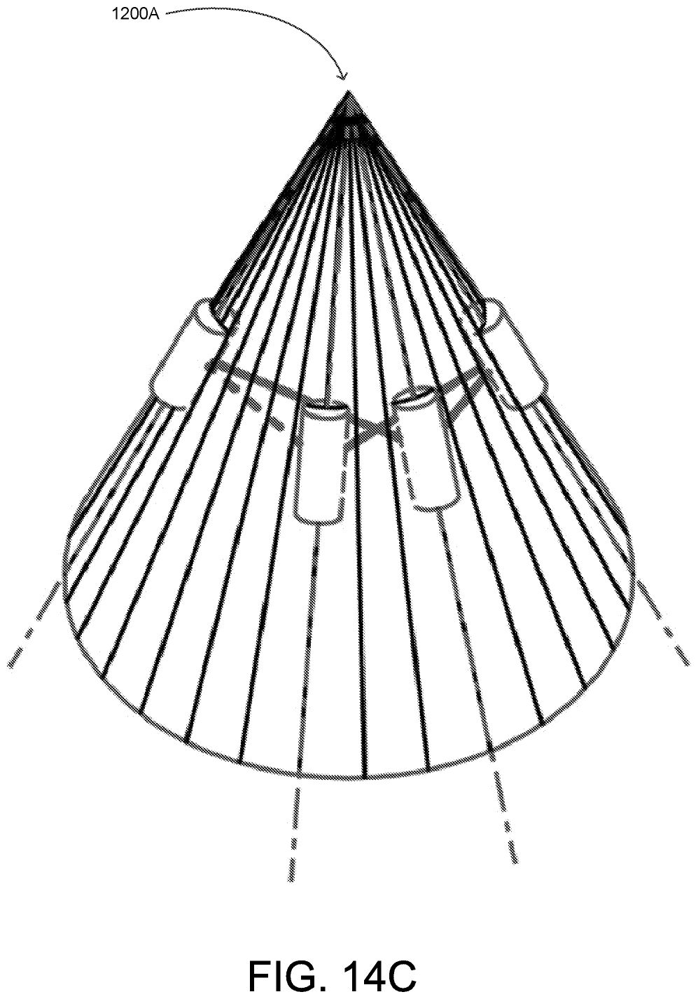

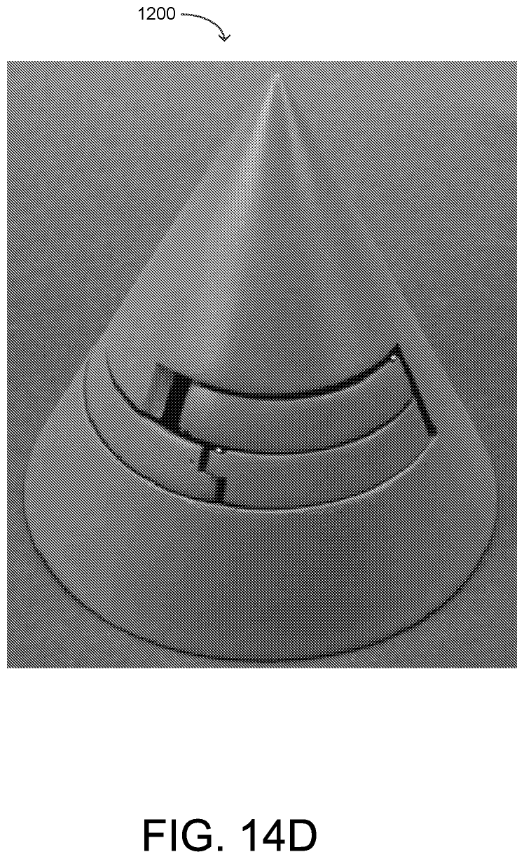

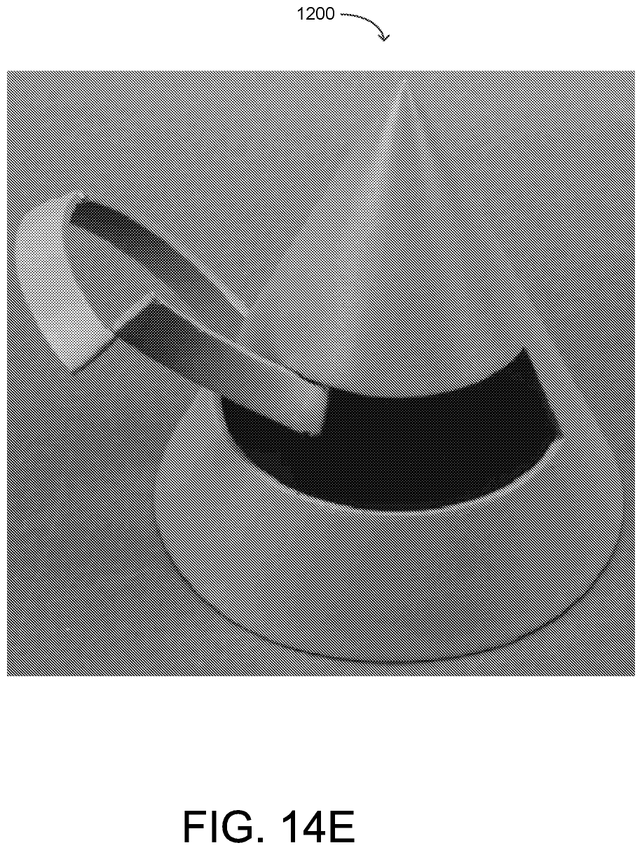

FIG. 14A shows a schematic 1200A cone with ruling lines 1202. While a right or regular circular cone is shown in FIG. 14A, the techniques and features described herein can be applied to any generalized cone, such as an oblique circular cone and/or an oblique elliptical cone. The ruling lines 1202 can converge at an apex 1203 of the schematic cone 1200A. The apparatus 1200 described above can, in the stowed, conformed, and/or closed position, define at least a portion of the schematic cone 1200A.

FIG. 14B shows joints 1402, 1404, 1406, 1408 with axes 1204, 1206, 1208, 1210 aligned with the ruling lines of FIG. 14A. The axes 1204, 1206, 1208, 1210 point toward the apex 1203 of the schematic cone 1200A. The joints 1402, 1404, 1406 1408 can represent joints 1228, 1230, 1232, 1234, 1236, 1238 described above.

FIG. 14C shows the schematic cone 1200A of FIG. 14A with the joints of FIG. 14B. While not labeled, axes of the joints point toward the apex of the schematic cone 1200A.

FIG. 14D shows an apparatus 1200 with multiple links defining at least a portion of a cone in a stowed position. In the stowed, conforming, and/or closed position, the links (not labeled in FIG. 14D) define at least a portion of a cone.

FIG. 14E shows the apparatus 1200 of FIG. 14D in a deployed position. In this deployed, actuated, and/or open position, at least two of the links (not labeled in FIG. 14E) no longer define the cone, and/or have moved away from the cone. In this deployed, actuated, and/or open position, axes of joints (not labeled in FIG. 14E) still point toward an apex of the cone.

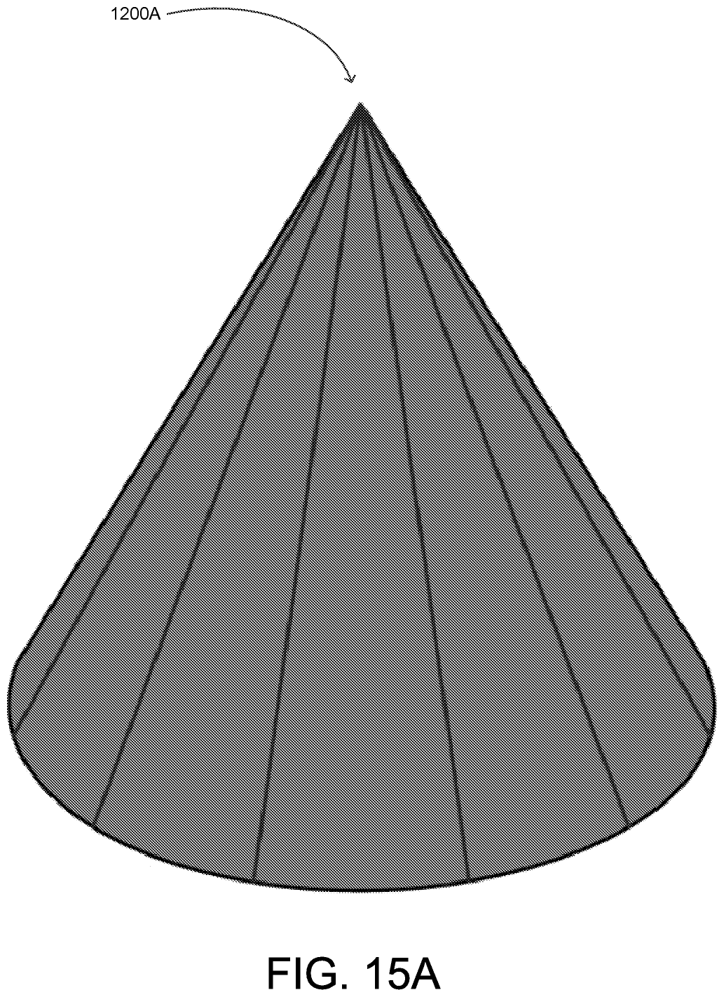

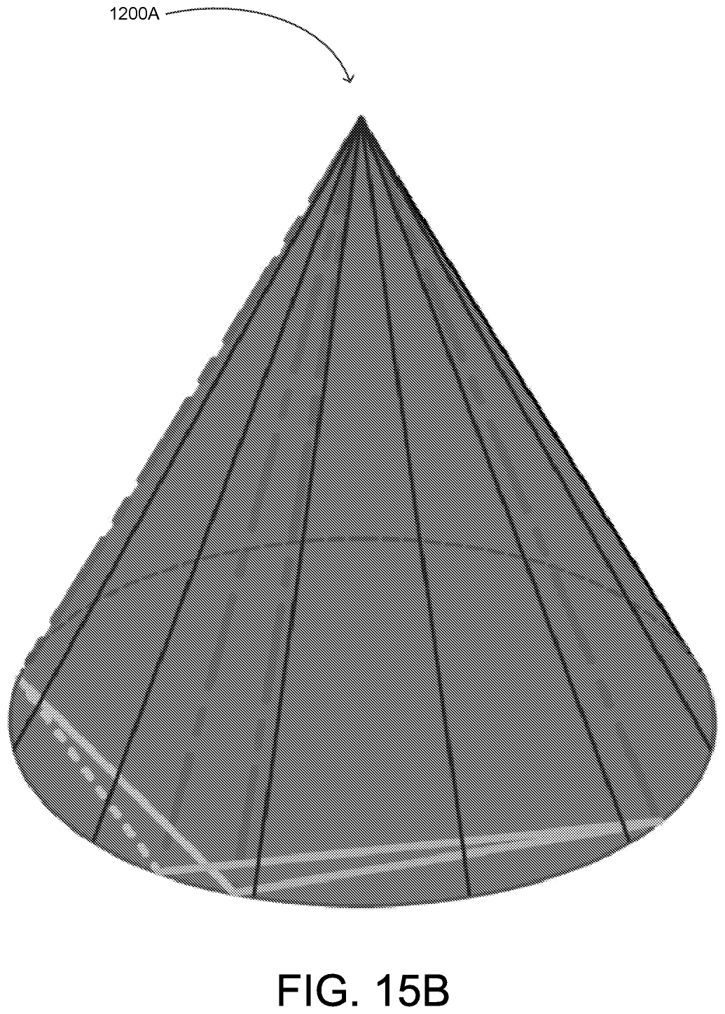

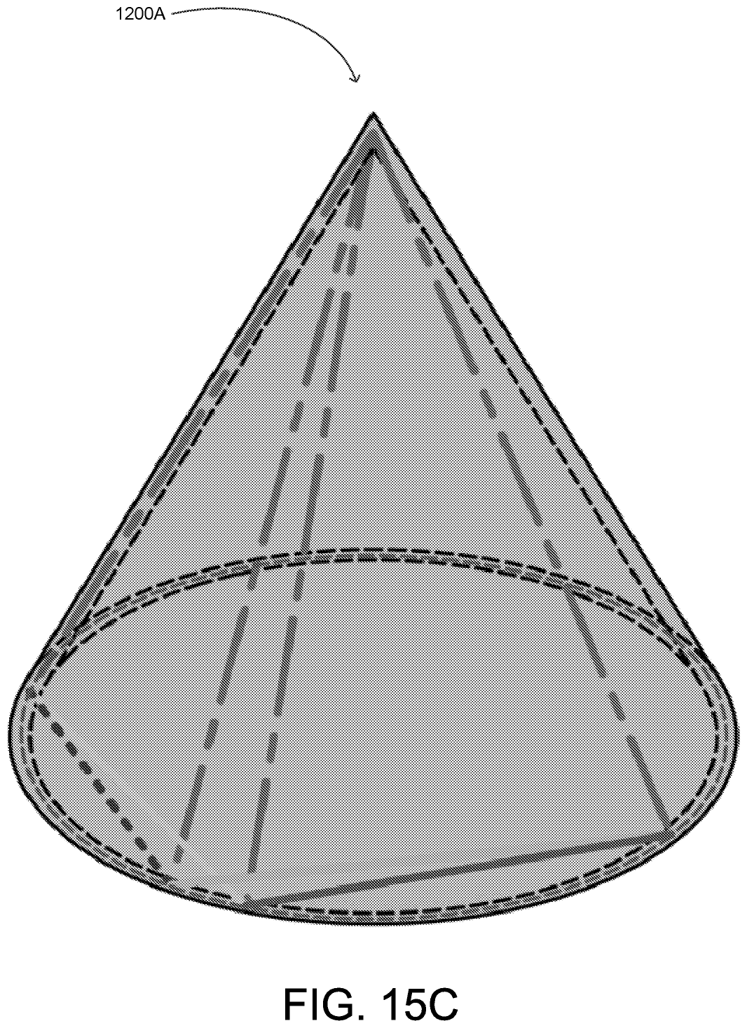

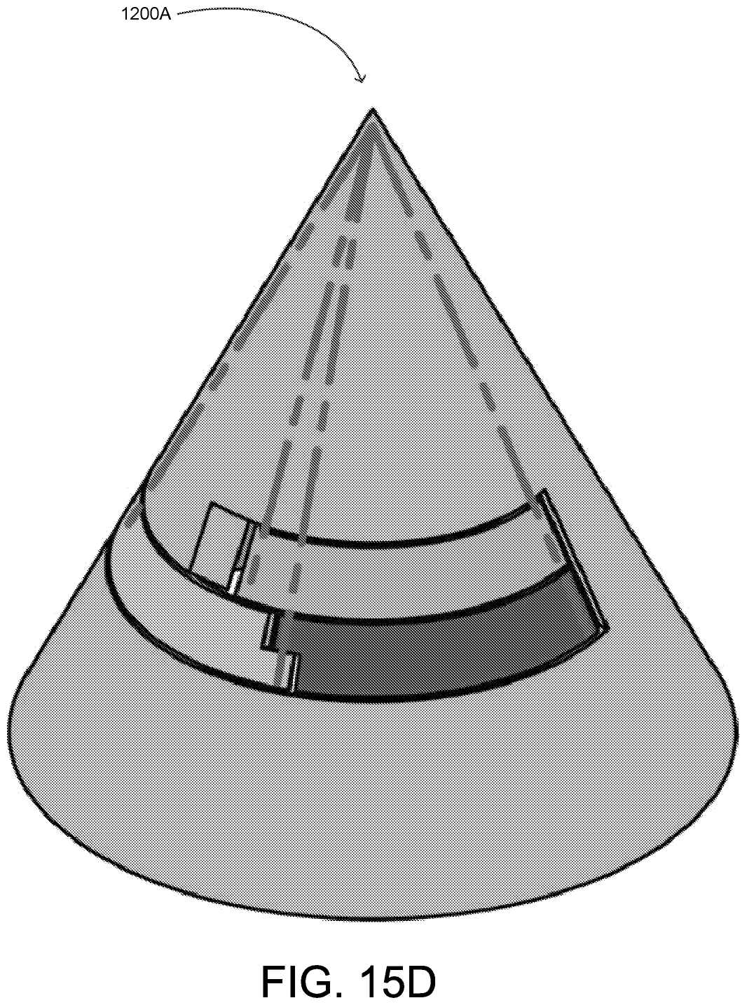

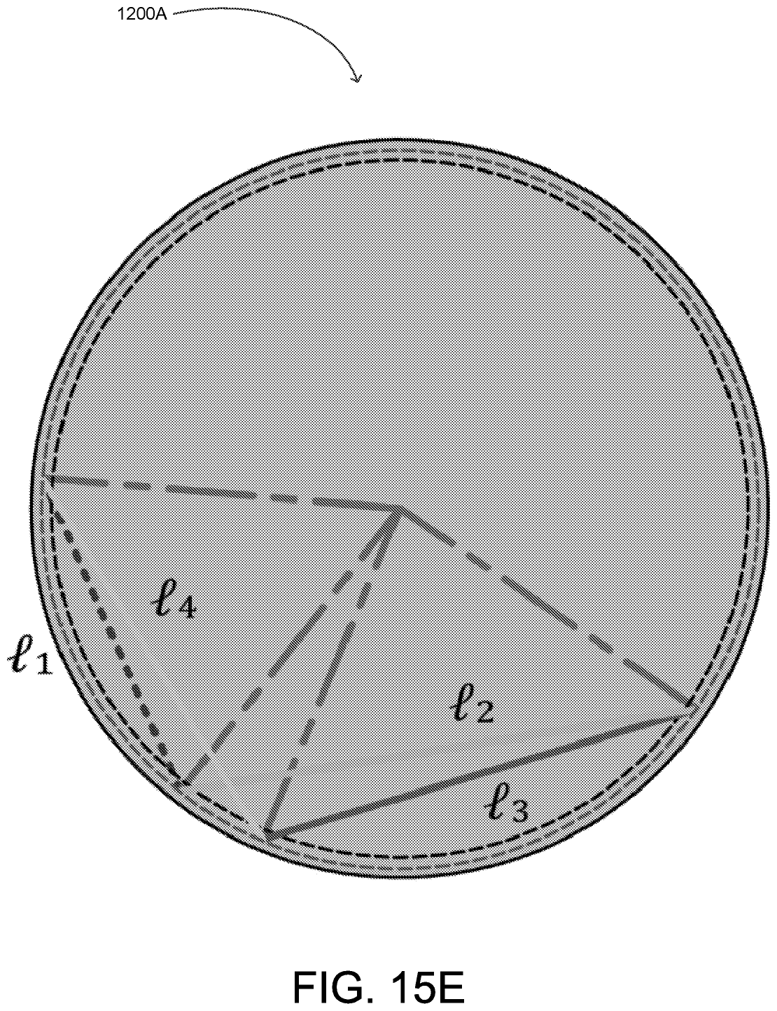

FIGS. 15A, 15B, 15C, 15D, and 15E show a schematic cone. These figures show ruling lines, links, joints, and joint axes extending along the ruling lines in a schematic based upon which an apparatus 1200 can be built.

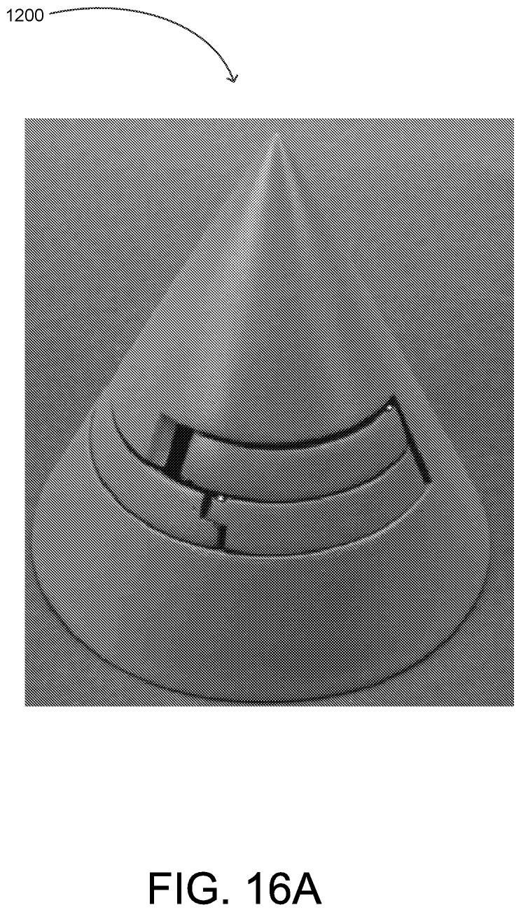

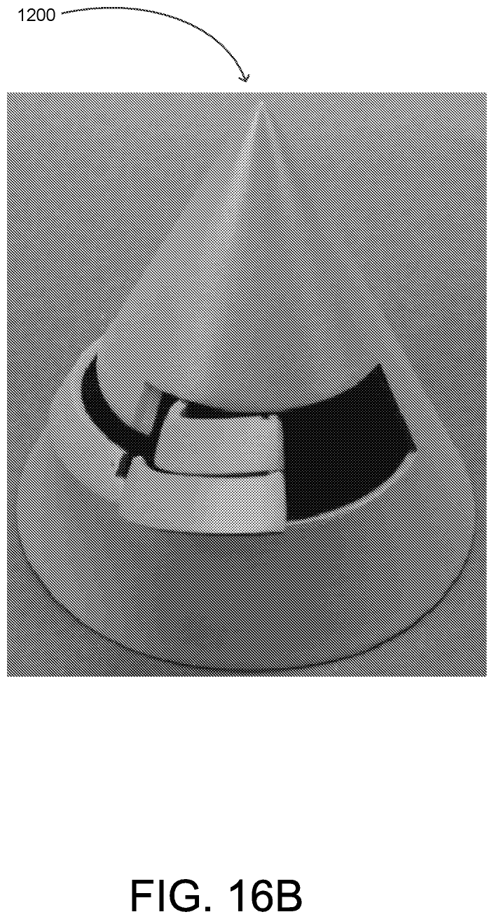

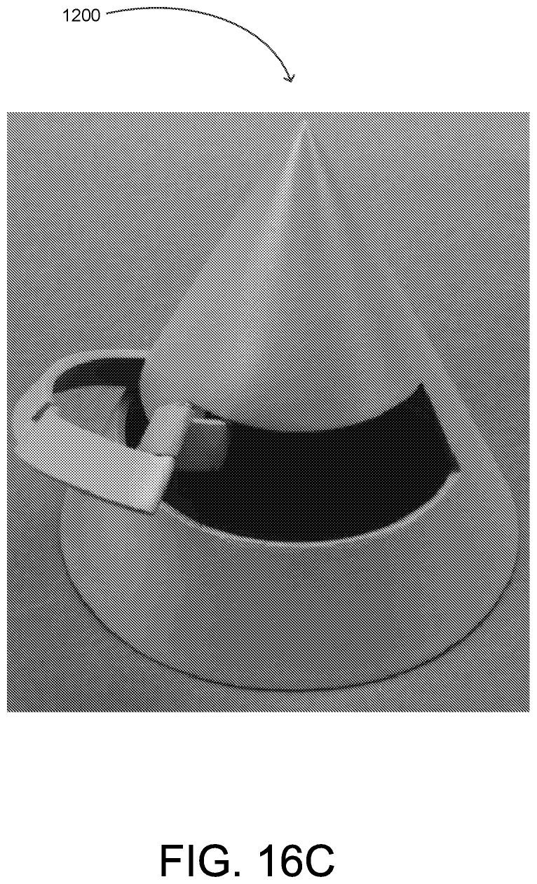

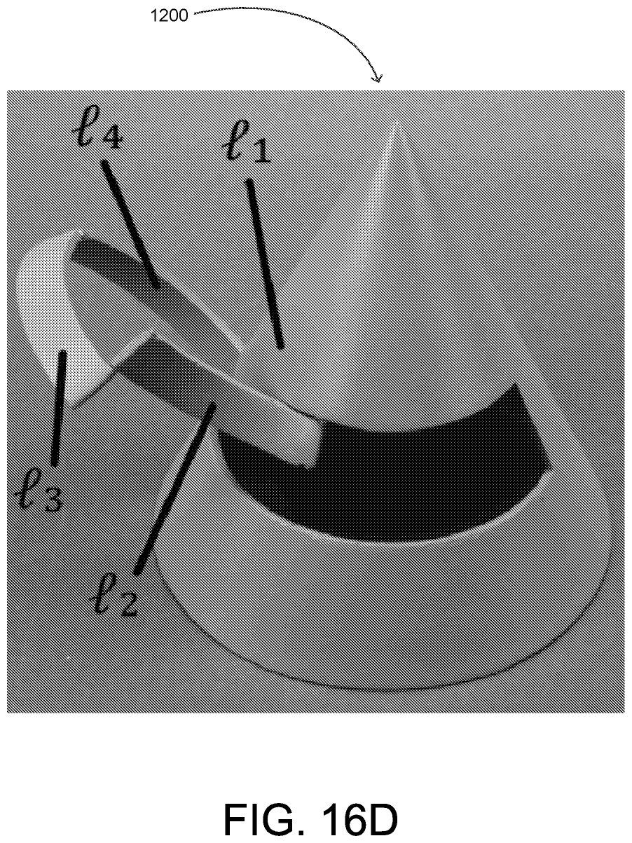

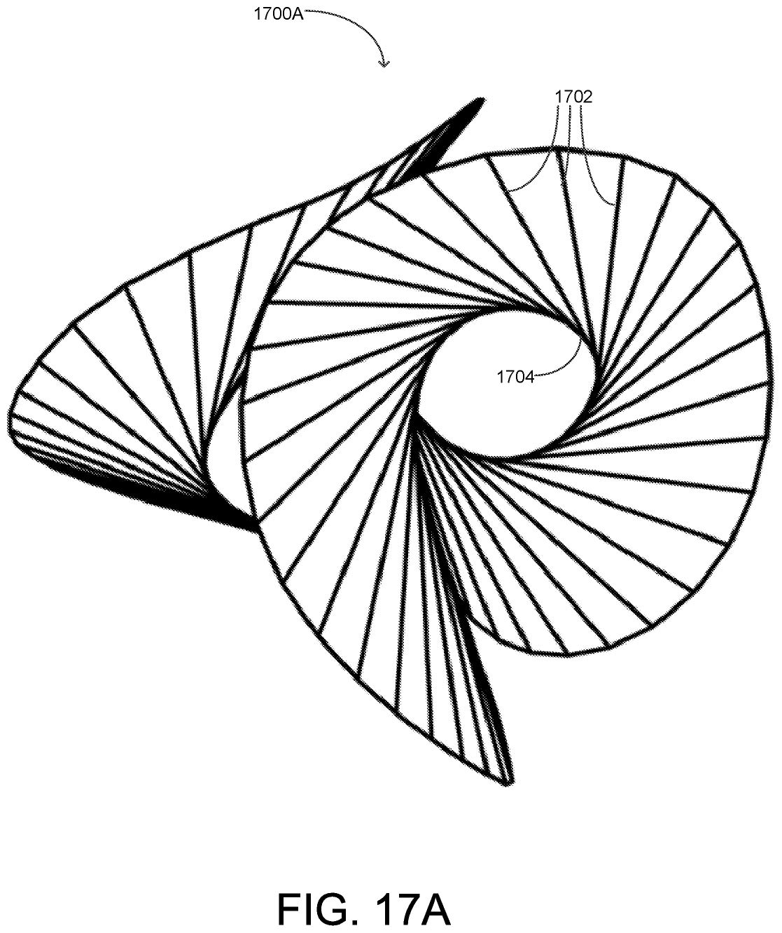

FIG. 16A shows an apparatus 1200 with multiple links defining at least a portion of a cone in a stowed position. In the stowed, conforming, and/or closed position, the links (not labeled in FIG. 14D) define at least a portion of a cone.

FIGS. 16B, 16C, and 16D show the apparatus 1200 of FIG. 16A in a deployed position. In these deployed, actuated, and/or open positions, at least two of the links (not labeled in FIG. 16B, 16C, or 16D) no longer define the cone, and/or have moved away from the cone. In these deployed, actuated, and/or open positions, axes of joints (not labeled in FIG. 16B, 16C, or 16D) still point toward an apex of the cone.

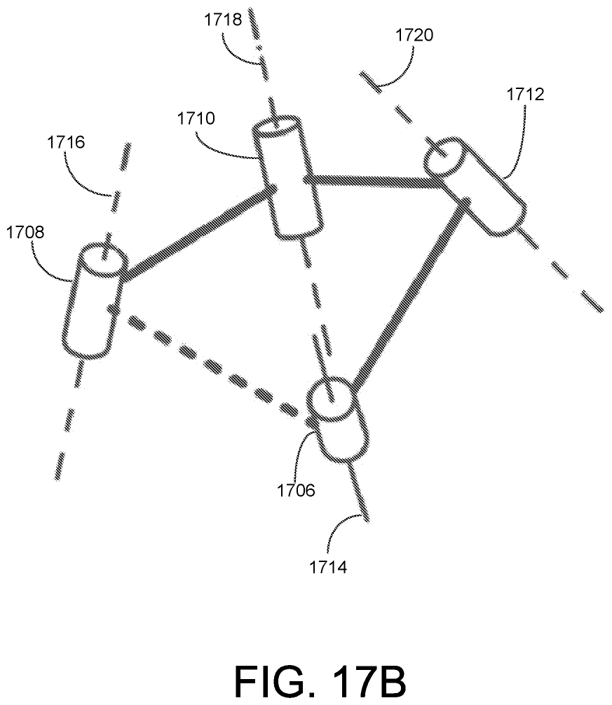

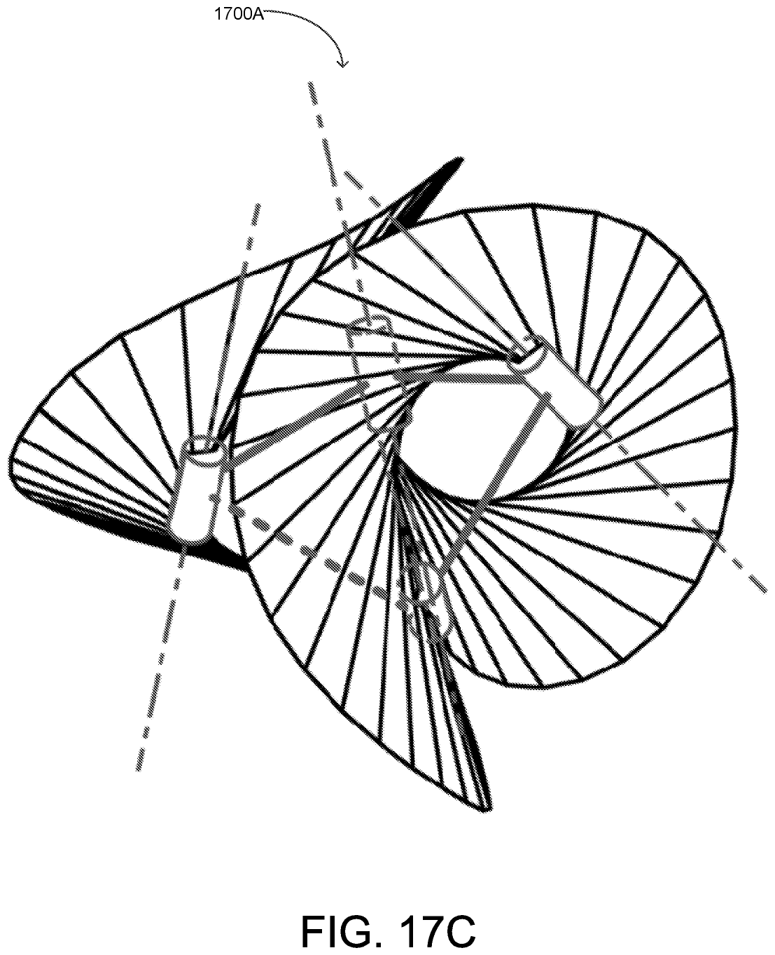

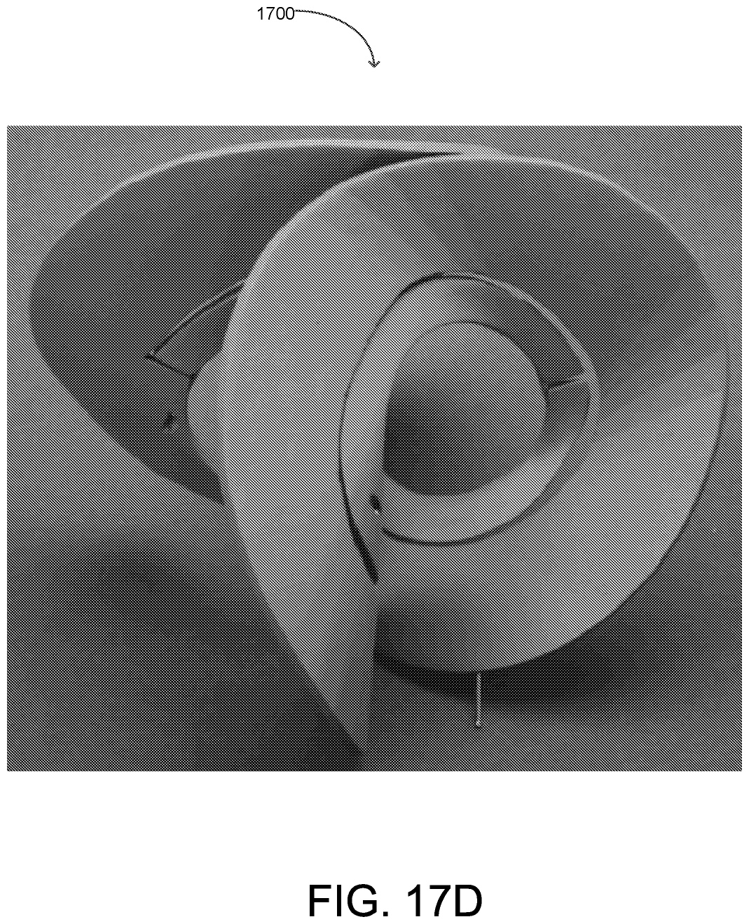

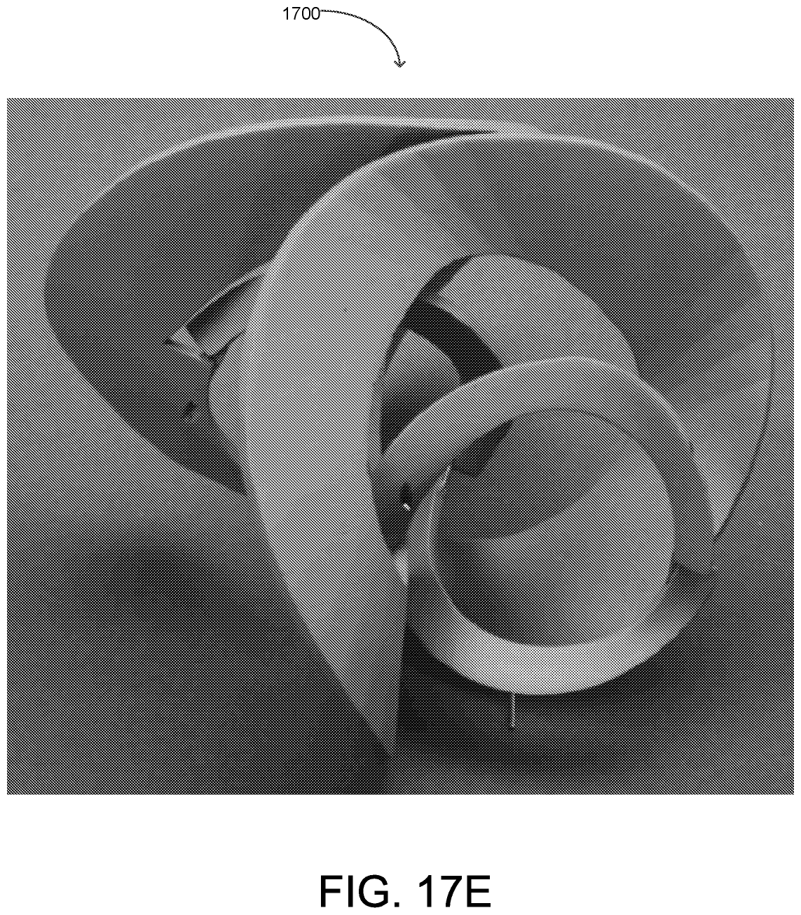

FIG. 17A shows a schematic tangent mechanism 1700A with ruling lines 1702. While only two ruling lines 1702 are shown in FIG. 17A, the schematic tangent mechanism 1700A can include any number of ruling lines 1702. The schematic tangent mechanism 1700A can include a curved surface. The ruling lines 1702 can extend from tangents of an inner surface 1704 and/or edge of the schematic tangent mechanism 1700A.

FIG. 17B shows joints 1706, 1708, 1710, 1712 with joint axes 1714, 1416, 1718, 1720 aligned with the ruling lines 1702 shown in FIG. 17A. All of the joints 1706, 1708, 1710, 1712 and their associated joint axes 1714, 1416, 1718, 1720 can extend along ruling lines 1702.

FIG. 17C shows the schematic tangent mechanism 1700A of FIG. 17A with the joints 1706, 1708, 1710, 1712 of FIG. 17B. The joints (not labeled in FIG. 17C) extend along ruling lines. Links are formed between joints. The axes of the joints are parallel to tangents of the curved surface.

FIG. 17D shows an apparatus 1700 with multiple links (not labeled in FIG. 17D) defining at least a portion of a curved surface and joints parallel to tangents of the curved surface in a stowed position. The apparatus 1700 can include any combination of features of the schematic tangent mechanism 1700A described above.

The multiple links can comprise at least a first link, a second link, a third link, and a base link. Each of the links can comprise a rigid sheet, such as metal or plastic. The first link can be hingedly coupled to the second link via a first joint. The second link can be hingedly coupled to the third link via a second joint. The third link can be hingedly coupled to the base link via a third joint. The base link can be hingedly coupled to the first link via a fourth joint. In some examples, the joints can disposed in locations corresponding to the joints 1706, 1708, 1710, 1712 shown in FIGS. 17B and 17C. An axis of the first joint can be parallel to, and/or extend along, a first tangent of the curved surface. An axis of the second joint can be parallel to, and/or extend along, a second tangent of the curved surface. An axis of the third joint can be parallel to, and/or extend along, a third tangent of the curved surface. An axis of the fourth joint can be parallel to, and/or extend along, a fourth tangent of the curved surface. In some examples, the first tangent can be tangent to an edge of the first link, the second tangent can be tangent to an edge of the second link, the third tangent can be tangent to an edge of the third link, and/or the fourth tangent can be tangent to an edge of the fourth link.

FIG. 17E shows the 1700 apparatus of FIG. 17D in a deployed position. In the deployed position, some of the links have moved away from the curved surface.

FIG. 18A is a schematic of a traditional joint 1802 and an associated axis 1804. The axis 1804 extends through the joint 1802.

FIG. 18B shows a traditional joint 1802 and links 1806, 1808 coupled via the traditional joint. The links 1806, 1808 can freely move about the axis 1804 of the joint 1802. The traditional joint 1802 has one degree of freedom, and is not biased toward either direction. The traditional joint 1802 can be used as a joint(s) in any of the apparatuses 100, 1200, 1700 described above.

FIG. 19A shows a schematic of a compliant joint 1902 and an associated axis 1904. The axis 1804 extends through the joint 1902. The joint 1902 can have one degree of freedom, and can be biased toward a first direction 1906 and/or first position.

FIG. 19B shows a compliant joint 1902 and links 1908, 1910 coupled via the compliant joint 1902. The compliant joint 1902 can be a living hinge. The compliant joint 1902 can be biased toward and particular position and/or orientation, such as to bring the links 1908, 1910 to a stowed, conforming, and/or closed position. The compliant joint 1902 can be used as a joint(s) in any of the apparatuses 100, 1200, 1700 described above. The compliant joints can cause the links of any of the apparatuses 100, 1200, 1700 to be compliant, in which the links of the apparatus 100, 1200, 1700 are biased to return to, and/or remain in, the stowed, conforming, and/or closed position.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. An apparatus comprising:
multiple links, the multiple links comprising at least a first link, a second link, a third link, and a base link, each of the multiple links comprising a rigid sheet, the first link being hingedly coupled to the second link via a first joint, the second link being hingedly coupled to the third link via a second joint, the third link being hingedly coupled to the base link via a third joint, the base link being hingedly coupled to the first link via a fourth joint,
the multiple links defining at least a portion of a cylinder when the apparatus is in a stowed position, the first joint, second joint, third joint, and fourth joint being aligned parallel to each other and aligned parallel to a longitudinal axis of the cylinder.

2. The apparatus of claim 1, wherein the first joint is closer to the third joint than to the second joint.

3. The apparatus of claim 1, wherein the cylinder has a same radius of curvature as the first link, the second link, the third link, and the base link.

4. The apparatus of claim 1, wherein, when the apparatus is in a deployed position and at least two of the multiple links no longer define the portion of the cylinder, the axes of the first joint, the second joint, the third joint, and the fourth joint are still aligned parallel to each other and aligned parallel to the longitudinal axis of the cylinder.

5. The apparatus of claim 1, further comprising:
the first joint;
the second joint;
the third joint; and
the fourth joint.

6. The apparatus of claim 5, wherein the first joint comprises a hinge.

7. The apparatus of claim 1, wherein the first joint comprises a flexure bearing with only a single degree of freedom.

8. The apparatus of claim 1, wherein the first joint comprises a living hinge with only a single degree of freedom.

9. The apparatus of claim 1, wherein the first joint comprises a torsion spring.

10. The apparatus of claim 1, wherein the first joint, second joint, third joint, and fourth joint are biased to the stowed position.

11. The apparatus of claim 1, wherein each of the first link, second link, and third link rotates no more than three hundred sixty degrees (360°) around the cylinder.

12. The apparatus of claim 1, wherein:
a mass of the base link is greater than a mass of the first link;
the mass of the base link is greater than a mass of the second link; and
the mass of the base link is greater than a mass of the third link.

13. The apparatus of claim 1, further comprising a rotation mechanism configured to rotate at least two of the multiple links with respect to each other.

14. An apparatus comprising:
multiple links, the multiple links comprising at least a first link, a second link, a third link, and a base link, each of the multiple links comprising a rigid sheet, the first link being hingedly coupled to the second link via a first joint, the second link being hingedly coupled to the third link via a second joint, the third link being hingedly coupled to the base link via a third joint, the base link being hingedly coupled to the first link via a fourth joint;
the multiple links defining at least a portion of a cone when the apparatus is in a stowed position, axes of the first joint, the second joint, the third joint, and the fourth joint pointing toward an apex of the cone.

15. The apparatus of claim 14, wherein the first joint is closer to the third joint than to the second joint.

16. The apparatus of claim 14, wherein, when the apparatus is in a deployed position and at least two of the multiple links no longer define the cone, the axes of the first joint, the second joint, the third joint, and the fourth joint still point toward the apex of the cone.

17. The apparatus of claim 14, further comprising a rotation mechanism configured to rotate at least two of the multiple links with respect to each other.

18. The apparatus of claim 14, wherein the multiple links further comprise a fourth link and a fifth link, the third link being hingedly coupled to the fourth link via a fifth joint, the fourth link being hingedly coupled to the fifth link via a sixth joint, the fifth link being hingedly coupled to the base link via a seventh joint.

19. An apparatus comprising:
multiple links, the multiple links comprising at least a first link, a second link, a third link, and a base link, each of the multiple links comprising a rigid sheet, the first link being hingedly coupled to the second link via a first joint, the second link being hingedly coupled to the third link via a second joint, the third link being hingedly coupled to the base link via a third joint, the base link being hingedly coupled to the first link via a fourth joint;
the multiple links defining at least a portion of a curved surface when the apparatus is in a stowed position, an axis of the first joint being parallel to a first tangent of the curved surface, an axis of the second joint being parallel to a second tangent of the curved surface, an axis of the third joint being parallel to a third tangent of the curved surface, and an axis of the fourth joint being parallel to a fourth tangent of the curved surface.

20. The apparatus of claim 19, wherein the first tangent of the curved surface is tangent to an edge of the first link.
